(19) United States
(12) Patent Application Publication
(10) Pub. No.: US 2026/0164124 A1
(43) Pub. Date: Jun. 11, 2026

(54) APPARATUS, METHOD THEREFOR, AND NON-TRANSITORY COMPUTER-READABLE STORAGE MEDIUM

(71) Applicant: CANON KABUSHIKI KAISHA, Tokyo (JP)

(72) Inventor: NAOMI MORI, Kanagawa (JP)

(21) Appl. No.: 19/409,333

(22) Filed: Dec. 4, 2025

(30) Foreign Application Priority Data
Dec. 11, 2024 (JP) 2024-216548

(51) Int. Cl. H04N 23/667; H04N 23/63

(52) U.S. Cl. CPC H04N 23/667; H04N 23/631

(57) ABSTRACT

An apparatus capable of setting a function concerning image creation from a plurality of functions includes a control unit which performs control to, in response to an item corresponding to the function concerning image creation having been selected in a first screen, display a selection screen for selecting a function to be executed from the plurality of functions and, in response to an instruction for detailed setting being issued in the selection screen, display a selection item for changing a setting value of the selected function, and performs control to, in response to an item corresponding to the function concerning image creation having been selected in a second screen, without the selection screen being displayed, display a selection item for changing a setting value of a predetermined function included in the plurality of functions in the second screen.

### BACKGROUND

### Field of the Technology

The aspect of the embodiments relates to an apparatus, a method therefor, and a non-transitory computer-readable storage medium.

### Description of the Related Art

Since the main body of a camera is equipped with a large number of functions and the number of functions which are complicated in settings thereof is large, a setting screen structure which facilitates understanding of each function is requested and, on the other hand, a setting screen structure which enables promptly making a change in settings without missing a photo opportunity is also requested.

Therefore, with regard to a setting screen in a camera, in a case where settings are performed via a menu screen, a screen structure which facilitates understanding of the overall functions by enabling comprehensively performing settings on the overall functions and which does not confuse the user is employed to make it easy to understand. On the other hand, with regard to quick settings for the time of image capturing, functions the settings of which the user wants to promptly change are displayed only in a simple display format, thus enabling the user to promptly select a desired setting item.

Japanese Patent Laid-Open No. 2018-97617 describes a camera which enables changing the structure of a menu first layer by changeover between standard settings and simple settings.

### SUMMARY

According to an aspect of the embodiments, an apparatus capable of setting, from a plurality of functions, a function concerning image creation to be performed on an image captured by a capturing unit includes the capturing unit, at least one memory storing a program, and at least one processor that when executing the program causes the at least one processor to perform control to, in response to an item corresponding to the function concerning image creation having been selected in a first screen, display a selection screen used for selecting a function to be executed from the plurality of functions and setting the selected function and, in response to a predetermined operation for changing a setting value of the currently selected function having been performed in the selection screen, display a selection item for changing the setting value of the function selected in the selection screen; and perform control to, in response to an item corresponding to the function concerning image creation having been selected in a second screen, without the selection screen being displayed, display a selection item for changing a setting value of a predetermined function included in the plurality of functions in the second screen.

Features of the disclosure will become apparent from the following description of embodiments with reference to the attached drawings. The following description of embodiments is described by way of example.

### BRIEF DESCRIPTION OF THE DRAWINGS

FIGS. 1A and 1B are appearance diagrams of a digital camera according to an embodiment.

FIG. 2 is a block diagram illustrating a configuration example of the digital camera according to the embodiment.

FIG. 3 is a flowchart illustrating the entire processing which the digital camera according to the embodiment performs.

FIG. 4A is a flowchart illustrating color mode selection screen display processing.

FIG. 4B is a flowchart illustrating the color mode selection screen display processing.

FIG. 5 is a flowchart illustrating menu screen display processing.

FIG. 6 is a flowchart illustrating quick setting screen display processing for the time of image capturing.

FIG. 7 is a flowchart illustrating the quick setting screen display processing for the time of image capturing.

FIG. 8 is a flowchart illustrating the quick setting screen display processing for the time of image capturing.

FIG. 9 is a diagram illustrating a display example of an image capturing standby screen and screen transitions.

FIGS. 10A, 10B, and 10C are diagrams illustrating display examples of a menu screen and a normal color mode selection screen and screen transitions.

FIGS. 11A, 11B, and 11C are diagrams illustrating display examples of a live view quick menu (LVQ) screen and an LVQ color mode selection screen and screen transitions.

FIG. 12 is a diagram illustrating display examples of an operating level control quick menu (OLCQ) screen and screen transitions.

FIGS. 13A, 13B, 13C, and 13D are diagrams illustrating display examples of a cinema quick menu (cinema Q) screen.

FIGS. 14A, 14B, 14C, and 14D are diagrams illustrating modification examples of display screens.

### DESCRIPTION OF THE EMBODIMENTS

Various embodiments, features, and aspects of the disclosure will be described in detail below with reference to the drawings.

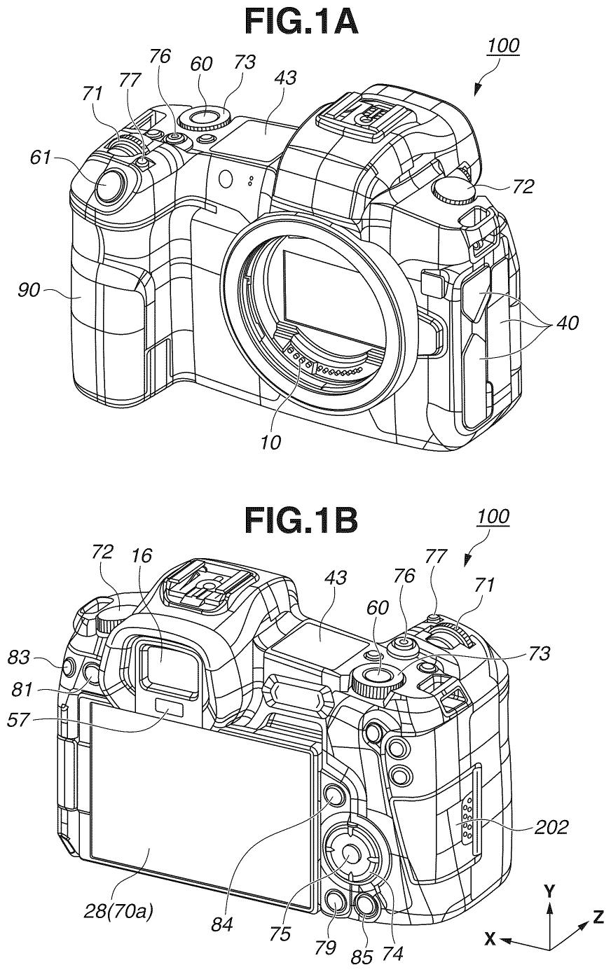

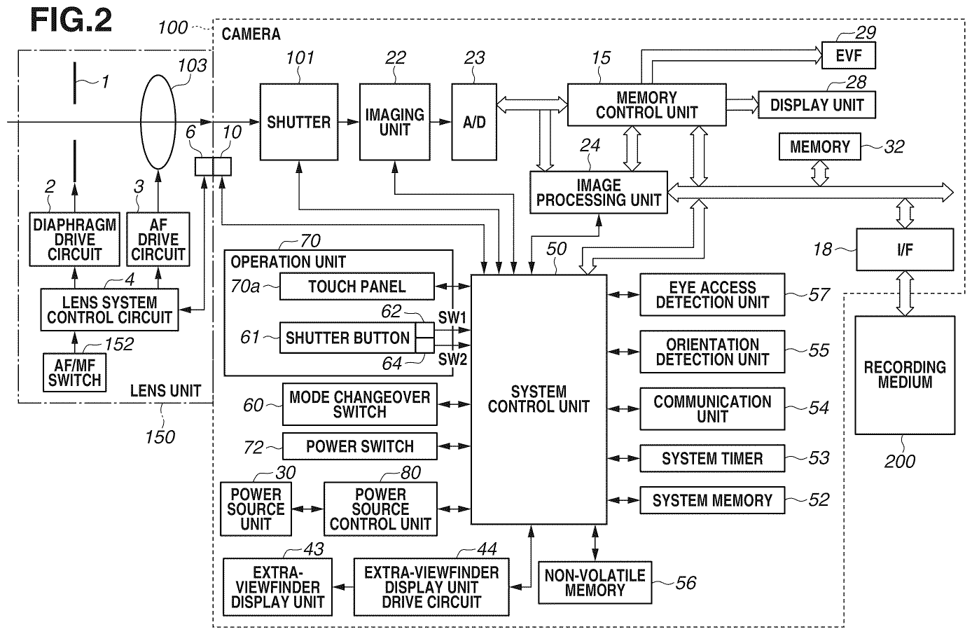

FIGS. 1A and 1B are appearance diagrams of a digital camera (hereinafter referred to simply as a “camera”) 100 serving as an example of an image capturing apparatus according to an embodiment. FIG. 1A is a front perspective view of the camera 100, and FIG. 1B is a back perspective view of the camera 100. A lens unit 150 (see FIG. 2) described below is attachable to and detachable from the camera 100.

A display unit 28 is a display unit provided on the back surface of the camera 100, and displays images and various pieces of information. A touch panel 70a detects a touch operation performed on the display surface (touch operation surface) of the display unit 28. An extra-viewfinder display unit 43 is a display unit provided on the top surface of the camera 100, and displays various setting values such as a shutter speed and an aperture value. A shutter button 61 is an operation member which is used to issue an image capturing instruction. A mode changeover switch 60 is an operation member which is used to change over between various modes. A terminal cover 40 is a cover which protects connectors (not illustrated) which are used to connect the camera 100 to, for example, a connection cable for external equipment.

A main electronic dial 71 is a rotary operation member and is used to, for example, change setting values such as a shutter speed and an aperture value. A power switch 72 is an operation member which is used to change over between power-on and power-off of the camera 100. A sub-electronic dial 73 is a rotary operation member and is used to, for example, move a selection frame (cursor or focus) or perform image forwarding. Arrow keys 74 are configured such that the upper, bottom, left, and right portions thereof are able to be individually pushed, such that processing associated with the pushed portion is performed. A SET button 75 is an operation member which is mainly used for, for example, determination of a selection item. A moving image button 76 is an operation member which is used to issue an instruction for starting or stopping moving image capturing (recording). A manual function (M-Fn) button 77 is an operation member which is used to, when being pressed with the camera 100 in an image capturing standby state, promptly change various settings such as white balance and International Organization for Standardization (ISO) sensitivity. A playback button 79 is an operation member which is used to change over between an image capturing mode and a playback mode. In response to the playback button 79 being pressed with the camera 100 in the image capturing mode, the camera 100 transitions to the playback mode, so that, among images which have been recorded on a recording medium 200 described below, the latest image is caused to be displayed on the display unit 28. A menu button 81 is an operation member which is used to perform an instruction operation for causing a menu screen to be displayed. In response to the menu button 81 being pressed, a menu screen which allows various settings is displayed on the display unit 28. The user is able to intuitively perform various settings with use of the menu screen displayed on the display unit 28 and the arrow keys 74 and the SET button 75. A COLOR button 83 is a button with the function of displaying a color mode selection screen on the display unit 28 allocated thereto. A quick menu (Q) button 84 is used to, when being pressed with the camera 100 in the image capturing standby state, cause a quick setting screen for the time of image capturing to be displayed on the display unit 28 or, when being pressed with the camera 100 in the playback state, cause a quick setting screen for the time of playback to be displayed on the display unit 28. An information (INFO) button 85 is used to, when being pressed with the camera 100 in the image capturing standby state or the playback state, change the form of the state displayed on the display unit 28 or, when being pressed when a setting screen is being displayed, cause a specific setting screen to be displayed on the display unit 28. For example, the M-Fn button 77 and the COLOR button 83, which are included in an operation unit 70, are configured to be able to be customized to allocation functions which the user desires.

A communication terminal group 10 is a communication terminal group via which the camera 100 performs communication with the lens unit 150. An eyepiece unit 16 is the eyepiece portion of an eyepiece viewfinder 17 (a looking-in type viewfinder), so that the user is able to visually recognize a video image displayed on an internal electronic viewfinder (EVF) 29 (FIG. 2) via the eyepiece unit 16. An eye access detection unit 57 is configured with an eye access detection sensor which detects whether the eye of the user (photographer) is accessing the eyepiece unit 16. A lid 202 is the lid of a slot which contains the recording medium 200. A grip portion 90 is a holding portion configured to be in a shape able to be easily gripped by the right hand of the user when the user holds the camera 100. The shutter button 61 and the main electronic dial 71 are arranged at positions where the shutter button 61 and the main electronic dial 71 are able to be operated with the index finger of the right hand in a state in which the user holds the camera 100 by gripping the grip portion 90 with the little finger, ring finger, and middle finger of the right hand. Moreover, the sub-electronic dial 73 is arranged at a position where the sub-electronic dial 73 is able to be operated with the thumb of the right hand in the same state.

FIG. 2 is a block diagram illustrating a configuration example of the camera 100 according to the embodiment. The same constituent elements as the constituent elements illustrated in FIGS. 1A and 1B are assigned the respective same reference characters as those in FIGS. 1A and 1B.

The lens unit 150 is detachably attached to the camera 100. The lens unit 150 includes a diaphragm 1, a lens 103, a diaphragm drive circuit 2, an autofocus (AF) drive circuit 3, a lens system control circuit 4, and a communication terminal group 6. The lens 103 is usually composed of a plurality of lens elements, but, in FIG. 2, is illustrated simply as a single lens element. The communication terminal group 6 is a communication terminal group used for the lens unit 150 to perform communication with the camera 100. The lens unit 150 performs communication with a system control unit 50 via the communication terminal groups 6 and 10. In the lens unit 150, the lens system control circuit 4 perform control of the diaphragm 1 via the diaphragm drive circuit 2. Moreover, in the lens unit 150, the lens system control circuit 4 varies the position of the lens 103 via the AF drive circuit 3, thus adjusting focus.

Moreover, on the lens barrel of the lens unit 150, an autofocus/manual-focus (AF/MF) switch 152 is mounted.

The AF/MF switch 152 is a focus mode setting unit and is a switch for switching the focus mode between AF and MF. The user is able to change over the position of the AF/MF switch 152 to select AF or MF. AF is used to adjust focus by varying the position of the lens 103 via the AF drive circuit 3. MF is used for the user to vary the position of the lens 103 by performing an MF operation.

A shutter 101 is a focal plane shutter capable of freely controlling the exposure time of an imaging unit 22 under the control of the system control unit 50.

The imaging unit 22 includes an image sensor configured with, for example, a charge-coupled device (CCD) sensor or a complementary metal-oxide semiconductor (CMOS) sensor, which converts an optical image into an electrical signal.

An analog-to-digital (A/D) converter 23 converts an analog signal output from the imaging unit 22 into a digital signal.

An image processing unit 24 performs predetermined processing operations (pixel interpolation, resizing processing such as reduction, and color conversion processing) on the data output from the A/D converter 23 or data read out from a memory control unit 15. Moreover, the image processing unit 24 performs predetermined calculation processing using the captured image data, and the system control unit 50 performs exposure control and distance measurement control based on a calculation result obtained by the image processing unit 24. With this, autofocus (AF) processing of the through-the-lens (TTL) type, automatic exposure (AE) processing, and electronic flash (EF) (flash preliminary light emission) processing are performed. Moreover, the image processing unit 24 further performs predetermined calculation processing using the captured image data, and performs automatic white balance (AWB) processing of the TTL type based on the obtained calculation result.

The memory control unit 15 controls data transmission and reception which are performed between the A/D converter 23, the image processing unit 24, and a memory 32. Data output from the A/D converter 23 is written in the memory 32 via the image processing unit 24 and the memory control unit 15 or directly via the memory control unit 15 without via the image processing unit 24. The memory 32 stores image data acquired by the imaging unit 22 and converted into digital data by the A/D converter 23 or image data that is to be displayed on the display unit 28 and the EVF 29. The memory 32 has a storage capacity sufficient to store a predetermined number of still images or a moving image and sound taken for a predetermined time. Moreover, the memory 32 also serves as a memory for image display (video memory). Image data for display written in the memory 32 is then displayed by the display unit 28 and the EVF 29 via the memory control unit 15. The display unit 28 and the EVF 29 perform displaying corresponding to the signal supplied from the memory control unit 15 on a display device, such as a liquid crystal display (LCD) or an organic electroluminescent display (EL). A digital signal obtained by A/D conversion performed once by the A/D converter 23 and stored in the memory 32 is sequentially transferred to the display unit 28 or the EVF 29 and displayed thereon, so that live view display is performed. Hereinafter, an image which is displayed in live view is referred to as a “live view image”.

The extra-viewfinder display unit 43 is configured to display various setting values, such as a shutter speed and an aperture value, via an extra-viewfinder display unit drive circuit 44.

A non-volatile memory 56 is an electrically erasable and recordable memory, for which, for example, a flash read-only memory (flash-ROM) is used. For example, constants and programs for operations of the system control unit 50 are stored in the non-volatile memory 56.

The system control unit 50 is a control unit composed of at least one processor or circuit, and controls the entire camera 100. The system control unit 50 implements various processing operations described below by executing a program stored in the non-volatile memory 56. Moreover, the system control unit 50 also performs display control by controlling, for example, the memory 32 and the display unit 28.

A system memory 52 is, for example, a random access memory (RAM). The system control unit 50 loads, on the system memory 52, for example, constants and variables for operations of the system control unit 50 and a program read out from the non-volatile memory 56.

A system timer 53 is a timer unit which measures times for use in various control operations and time in a built-in clock.

A power source control unit 80 is configured with, for example, a battery detection circuit, a DC-DC converter, and a switch circuit for switching blocks to be energized, and detects the presence or absence of attachment of a battery, the type of a battery, and the remaining amount of battery power. Moreover, the power source control unit 80 controls the DC-DC converter based on a result of such detection and an instruction from the system control unit 50, and supplies required voltages to various portions, including the recording medium 200, for respective required periods. A power source unit 30 includes, for example, a primary battery, such as an alkaline battery or a lithium battery, a secondary battery, such as a nickel-cadmium (NiCd) battery, a nickel-metal hydride (NiMH) battery, or a lithium (Li) battery, or an alternating current (AC) adapter.

An interface (I/F) 18 is an interface with the recording medium 200, such as a memory card or a hard disk. The recording medium 200 is a recording medium, such as a memory card, which is used to record an image obtained by image capturing, and is configured with, for example, a semiconductor memory or a magnetic disc.

A communication unit 54 performs transmission and reception of a video signal and an audio signal with external equipment connected thereto via wireless or via a wired cable. The communication unit 54 is also able to connect to a wireless local area network (LAN) or the Internet. Moreover, the communication unit 54 is also able to communicate with external equipment via Bluetooth^{®}or Bluetooth Low Energy. The communication unit 54 is able to transmit an image (including a live view image) captured by the imaging unit 22 and an image recorded on the recording medium 200, and is also able to receive image data or various other pieces of information from external equipment.

An orientation detection unit 55 detects the orientation of the camera 100 with respect to the direction of gravitational force. Whether an image captured by the imaging unit 22 is an image captured with the camera 100 held in a landscape orientation or an image captured with the camera 100 held in a portrait orientation can be discriminated based on the orientation detected by the orientation detection unit 55. The system control unit 50 is able to append orientation information corresponding to the orientation detected by the orientation detection unit 55 to an image file of the image captured by the imaging unit 22 or to perform recording with an image rotated. The orientation detection unit 55 to be used includes, for example, an acceleration sensor and a gyroscope sensor. The acceleration sensor or gyroscope sensor serving as the orientation detection unit 55 is able to be used to detect motions of the camera 100 (for example, panning, tilting, lifting, and being kept still or not).

The eye access detection unit 57 is an eye access detection sensor which detects the access (eye access) and the departure (eye departure) of the eye of the user (an object) with respect to the eyepiece unit 16 of the eyepiece viewfinder 17 (i.e., performs access detection). The system control unit 50 switches between displaying (display state) and non-displaying (non-display state) of each of the display unit 28 and the EVF 29 according to the state detected by the eye access detection unit 57. Specifically, in a case where the camera 100 is at least in an image capturing standby state and the switching setting for a display destination is automatic switching setting, during non-eye access, the system control unit 50 sets the display unit 28 as the display destination, thus turning on displaying of the display unit 28 and setting the EVF 29 to non-displaying. Moreover, during eye access, the system control unit 50 sets the EVF 29 as the display destination, thus turning on displaying of the EVF 29 and setting the display unit 28 to non-displaying. The eye access detection unit 57 can be configured with, for example, an infrared proximity sensor, and is able to detect the access of an object of some kind to the eyepiece unit 16 of the eyepiece viewfinder 17 having the EVF 29 incorporated therein. In a case where an object has accessed the eyepiece unit 16, infrared light projected from a light projection portion (not illustrated) of the eye access detection unit 57 is reflected from the object and is then received by a light receiving portion (not illustrated) of the eye access detection unit 57. The eye access detection unit 57 is also able to discriminate up to which distance to the eyepiece unit 16 the object has come close (eye access distance), based on the amount of the received infrared light. In this way, the eye access detection unit 57 performs eye access detection for detecting the access distance of the object to the eyepiece unit 16.

The mode changeover switch 60 switches an operation mode of the system control unit 50 to any one of, for example, a still image capturing mode, a moving image capturing mode, and a playback mode. Modes included in the still image capturing mode include an automatic image capturing mode, an automatic scene discrimination mode, a manual focusing (MF) mode, an aperture priority mode (Av mode), a shutter speed priority mode (Tv mode), and a program automatic exposure (AE) mode (P mode). Moreover, the modes included in the still image capturing mode further include, for example, various scene modes in which image capturing settings for the respective image capturing scenes are performed and a custom mode. The mode changeover switch 60 is used to directly switch the operation mode of the system control unit 50 to any one of these modes. Alternatively, after switching to displaying of a list screen for image capturing modes is once performed by the mode changeover switch 60, another operation member can also be used to perform switching to any one of a plurality of image capturing modes displayed in the list screen. Likewise, a plurality of modes can also be included in the moving image capturing mode.

The power switch 72 is used to switch between power-on and power-off of the camera 100.

The operation unit 70 is an input unit which receives a user operation, and is used to input various operation instructions to the system control unit 50. The operation unit 70 includes the shutter button 61 and the touch panel 70a and further includes, although not illustrated in FIG. 2, the main electronic dial 71, the sub-electronic dial 73, the arrow keys 74, the SET button 75, the moving image button 76, the M-Fn button 77, the playback button 79, and the menu button 81. The camera 100 in the embodiment also includes, as illustrated in FIG. 1B, the COLOR button 83, the Q button 84, and the INFO button 85.

The shutter button 61 includes a first shutter switch 62 and a second shutter switch 64. The first shutter switch 62 is configured to be turned on in response to a halfway operation, in other words, a half-pressed state, of the shutter button 61 (an image capturing preparation instruction), thus generating a first shutter switch signal SW1. In response to the first shutter switch signal SW1, the system control unit 50 starts image capturing preparation operations, such as autofocus (AF) processing, automatic exposure (AE) processing, automatic white balance (AWB) processing, and flash preliminary emission (EF) processing. The second shutter switch 64 is configured to be turned on in response to a complete operation, in other words, a fully-pressed state, of the shutter button 61 (an image capturing instruction), thus generating a second shutter switch signal SW2. In response to the second shutter switch signal SW2, the system control unit 50 starts a series of image capturing processing operations starting with a signal readout operation from the imaging unit 22 and leading to a writing operation for the captured image data as an image file to the recording medium 200.

The touch panel 70a is a touch sensor for detecting various touch operations on the display surface (operation surface of the touch panel 70a) of the display unit 28. The touch panel 70a and the display unit 28 can be configured in an integrated manner. For example, the touch panel 70a is configured to have such a light transmittance as not to hinder displaying performed by the display unit 28, and is attached to the upper layer of a display surface of the display unit 28. Then, the input coordinates in the touch panel 70a are associated with the display coordinates on a display screen of the display unit 28. With this, a graphical user interface (GUI) can be provided as if the user were able to directly operate a screen displayed on the display unit 28.

The camera 100 according to the embodiment includes three functions, i.e., a picture style function, a color filter function, and a custom picture function, as an image processing function concerning image creation which is performed by the image processing unit 24 on a captured image.

In one embodiment, the picture style function is a function which enables obtaining an effective image characteristic only by selecting one of prepared items in conformity with a photographic expression or a subject. Adjustment values for color tones are preliminarily set for respective image capturing scenes or styles, such as [portrait], [landscape], [standard], and [attention to detail], and, in response to the user selecting one of the image capturing scenes or styles, an automatic adjustment of color tone which has preliminarily been set is performed. With regard to the automatic adjustment of color tone, it is also possible for the user to preliminarily set, in detail, adjustment values for, for example, the strength, fineness, and threshold of sharpness, contrast, and color density.

The color filter function is a function in which the user selects one color filter effect from among a plurality of color filter effects, such as “StoryTeal&Orange”, “StoryMagenta”, and “StoryBlue”, and applies the selected color filter effect to an image.

The custom picture effect enables setting a custom picture file in which settings for performing image creation through a combination of, for example, gamma or color space, color matrix, and a Look file for adjusting color hues have been described. The custom picture effect is a function for, by the setting of the custom picture file, capturing an image with an image characteristic tailored to the purpose.

These three functions concerning image creation, i.e., the picture style function, color filter function, and custom picture function, are functions only any one of which becomes able to be effected at the time of capturing of an image and are subjected to exclusive control. Thus, if one function is set, the other functions become disabled and are not executed. Therefore, in the camera 100 according to the embodiment, such three functions concerning image creation are collectively referred to as a “color mode function”, and the camera 100 is provided with a color mode selection screen for selecting one function to be executed from among the three functions.

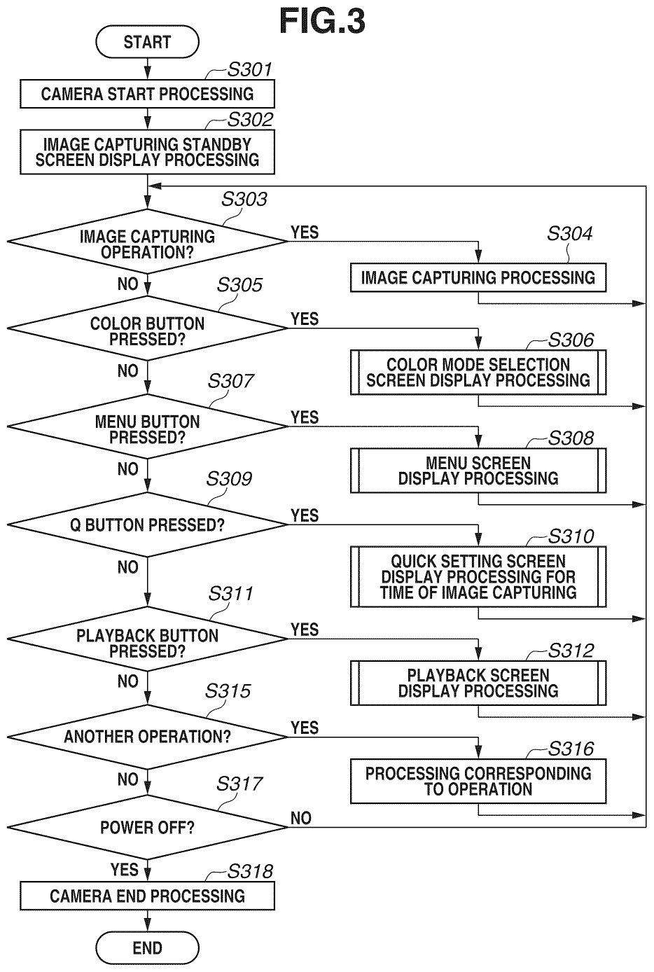

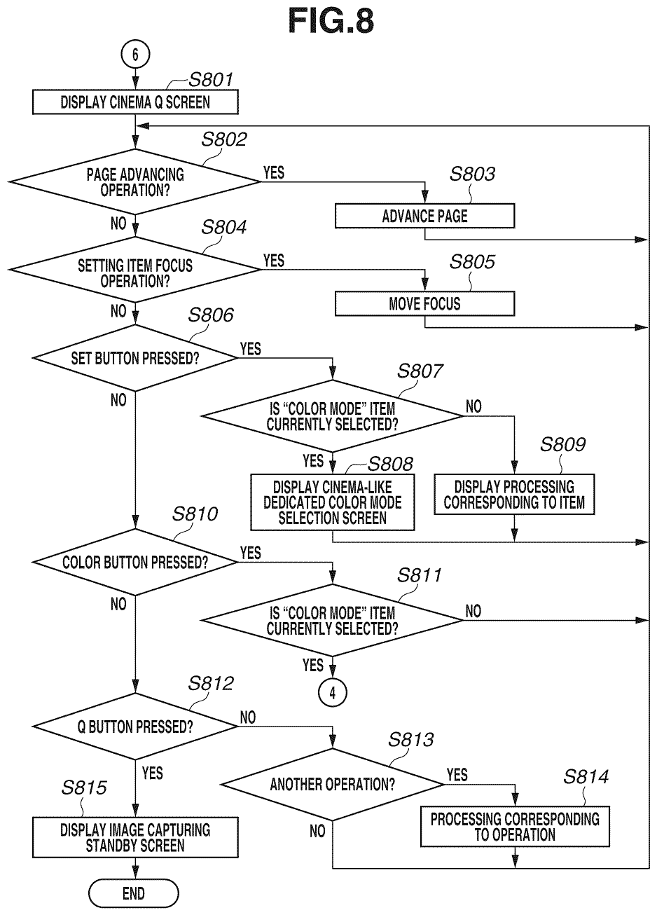

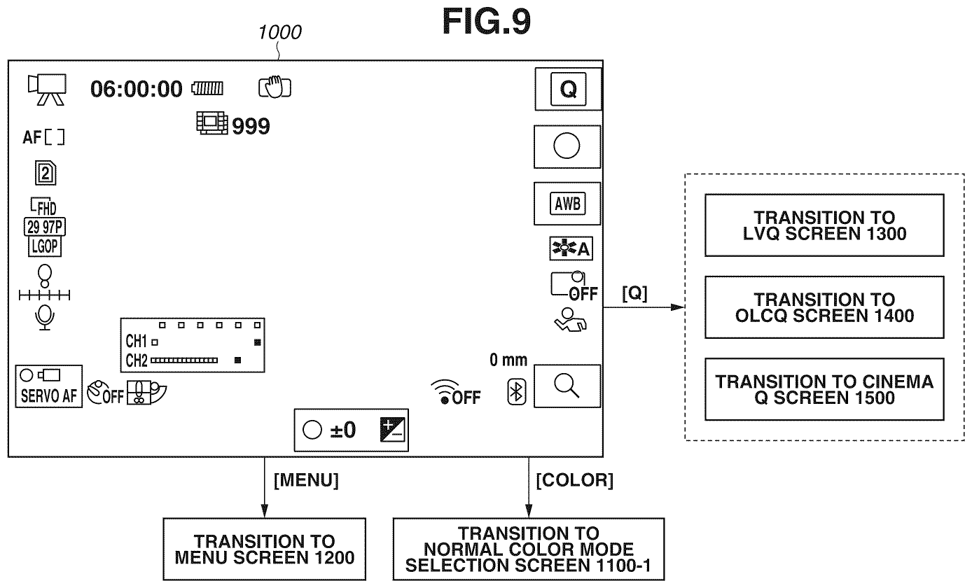

Processing (particularly, processing concerning screen transition) which is performed in the camera 100 is described with reference to the flowcharts of FIG. 3 to FIG. 8 and display examples of screens and transition examples of screen display illustrated in FIG. 9 to FIGS. 11A, 11B, and 11C. Processing illustrated in the flowcharts of FIG. 3 to FIG. 8 is implemented by the system control unit 50 loading a program stored in the non-volatile memory 56 onto the system memory 52 and performing various computation processing operations and control operations for the respective units.

FIG. 3 is a flowchart illustrating the entire processing which the camera 100 according to the embodiment performs. This processing is started in response to the user powering on the camera 100.

In step S301, the system control unit 50 performs start processing for the camera 100. In the start processing, the system control unit 50 performs, for example, acquisition of data, such as setting values of functions and control values, from the non-volatile memory 56 and preparations for capturing a still image or moving image.

In step S302, the system control unit 50 displays an image capturing standby screen 1000 such as that illustrated in FIG. 9 on the display unit 28. In one embodiment, the image capturing standby screen 1000 has a plurality of display states, including, for example, displaying only a live view image, displaying setting values in superimposition on a live view, and displaying a control panel-like screen.

In step S303, the system control unit 50 determines whether an image capturing operation, which is caused by the operation of the second shutter switch 64 (SW2) of the shutter button 61 or an operation performed on the touch panel 70a, has been performed by the user, and, if it is determined that the image capturing operation has been performed (YES in step S303), the system control unit 50 advances the processing to step S304 and, if the image capturing operation has not been performed (NO in step S303), the system control unit 50 advances the processing to step S305.

In step S304, the system control unit 50 performs image capturing processing, and then returns the processing to step S303.

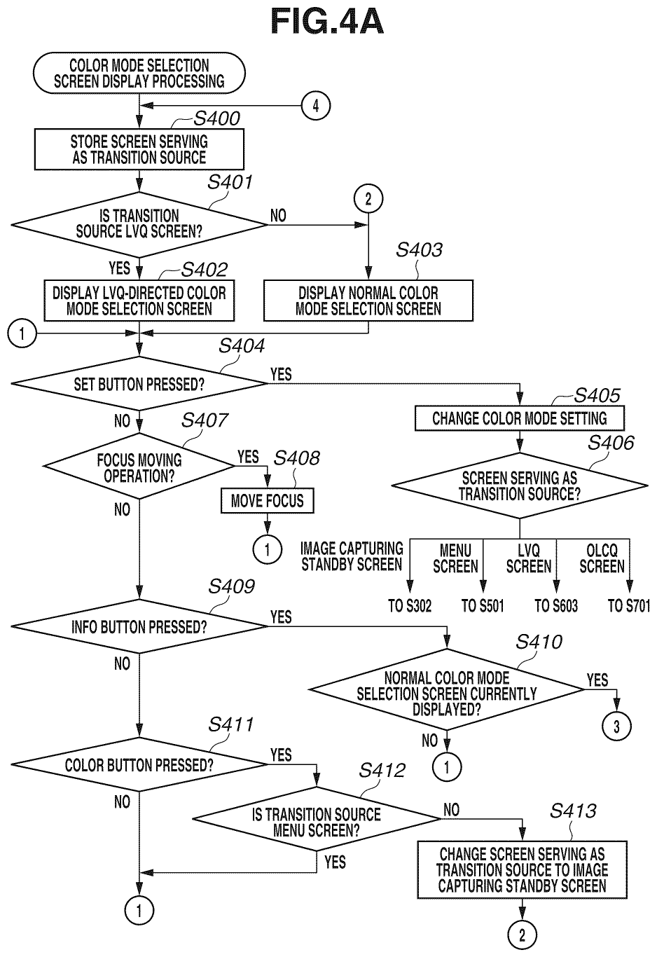

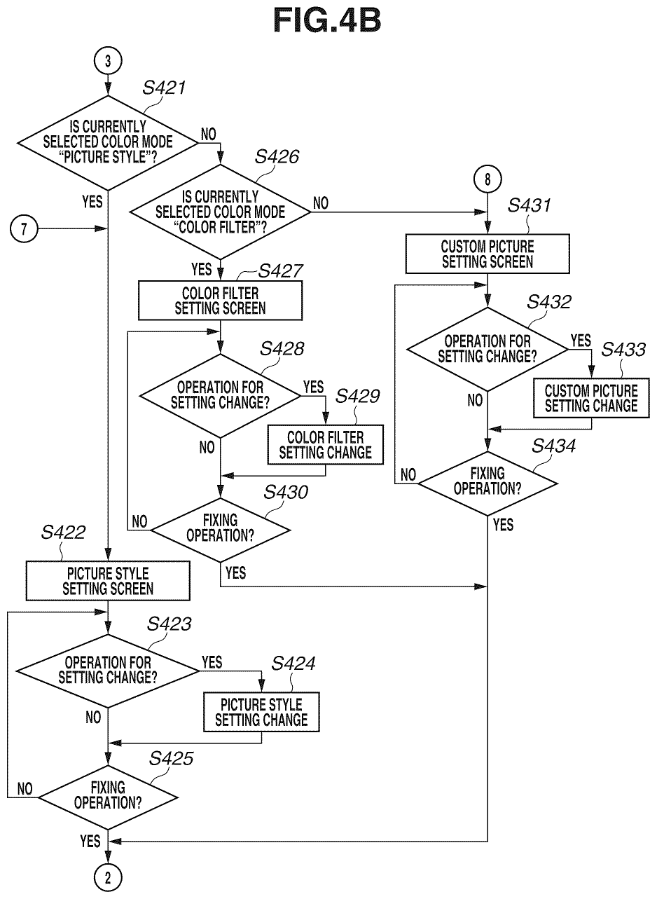

In step S305, the system control unit 50 determines whether the COLOR button 83 has been pressed, and, if it is determined that the COLOR button 83 has been pressed (YES in step S305), the system control unit 50 advances the processing to step S306 and, if it is determined that the COLOR button 83 has not been pressed (NO in step S305), the system control unit 50 advances the processing to step S307. In step S306, the system control unit 50 performs color mode selection screen display processing. While the color mode selection screen display processing is described below with reference to FIGS. 4A and 4B, in a case where the COLOR button 83 has been operated when the image capturing standby screen 1000 is being displayed as illustrated in FIG. 9, the display screen is switched from the image capturing standby screen 1000 to a normal color mode selection screen 1100-1.

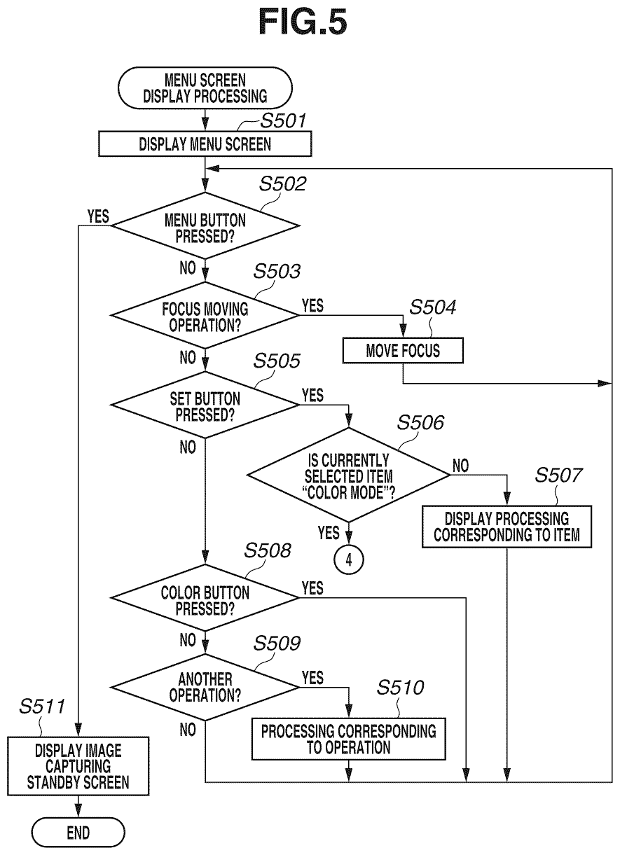

In step S307, the system control unit 50 determines whether the menu button (MENU button) 81 has been pressed, and, if it is determined that the MENU button 81 has been pressed (YES in step S307), the system control unit 50 advances the processing to step S308 and, if it is determined that the MENU button 81 has not been pressed (NO in step S307), the system control unit 50 advances the processing to step S309. In step S308, the system control unit 50 performs menu screen display processing. While the menu screen display processing is described below with reference to FIG. 5, in a case where the MENU button 81 has been operated when the image capturing standby screen 1000 is being displayed as illustrated in FIG. 9, the display screen is switched from the image capturing standby screen 1000 to a menu screen 1200.

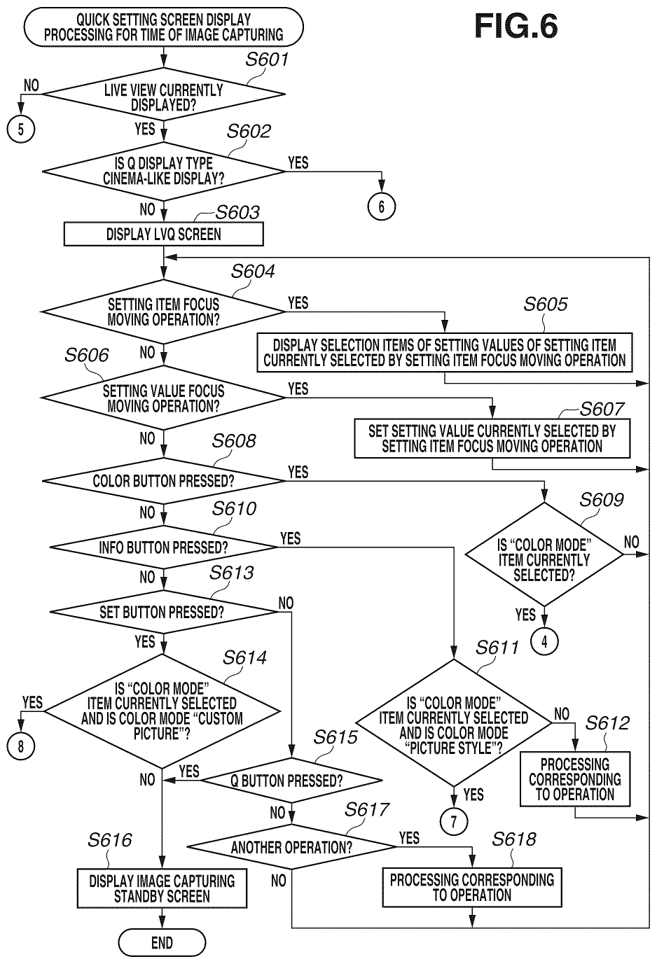

In step S309, the system control unit 50 determines whether the Q button 84 has been pressed or a Q icon in the image capturing standby screen 1000 has been touch-operated, and, if it is determined that such an operation has been performed (YES in step S309), the system control unit 50 advances the processing to step S310 and, if such an operation has not been performed (NO in step S309), the system control unit 50 advances the processing to step S311. In step S310, the system control unit 50 performs quick setting screen display processing. The quick setting screen display processing is described below with reference to FIG. 6 to FIG. 8. In a case where the Q button 84 has been operated when the image capturing standby screen 1000 is being displayed as illustrated in FIG. 9, the display screen is switched from the image capturing standby screen 1000 to any one of an LVQ screen 1300, an OLCQ screen 1400, and a cinema Q screen 1500.

In step S311, the system control unit 50 determines whether the playback button 79 has been pressed, and, if it is determined that the playback button 79 has been pressed (YES in step S311), the system control unit 50 advances the processing to step S312 and, if it is determined that playback button 79 has not been pressed (NO in step S311), the system control unit 50 advances the processing to step S315. In step S312, the system control unit 50 performs playback screen display processing.

In step S315, the system control unit 50 determines whether a user operation directed to an operation member other than the operation members mentioned in the above description included in the operation unit 70 has been performed, and, if it is determined that such a user operation has been performed (YES in step S315), the system control unit 50 advances the processing to step S316 and, if it is determined that such a user operation has not been performed (NO in step S315), the system control unit 50 advances the processing to step S317. The operation unit 70 includes, for example, the arrow keys 74, the moving image button 76, the main electronic dial 71, and the sub-electronic dial 73.

In step S316, the system control unit 50 performs processing corresponding to the operation determined to have been performed in step S315, and then returns the processing to step S303.

In step S317, the system control unit 50 determines whether the user has powered off the camera 100, and, if it is determined that the user has powered off the camera 100 (YES in step S317), the system control unit 50 advances the processing to step S318 and, if it is determined that the user has not powered off the camera 100 (NO in step S317), the system control unit 50 returns the processing to step S303.

In step S318, the system control unit 50 performs end processing for the camera 100, and then ends the processing illustrated in the flowchart of FIG. 3.

The color mode selection screen display processing, which is performed in, for example, step S306 illustrated in FIG. 3, is described with reference to FIGS. 4A and 4B.

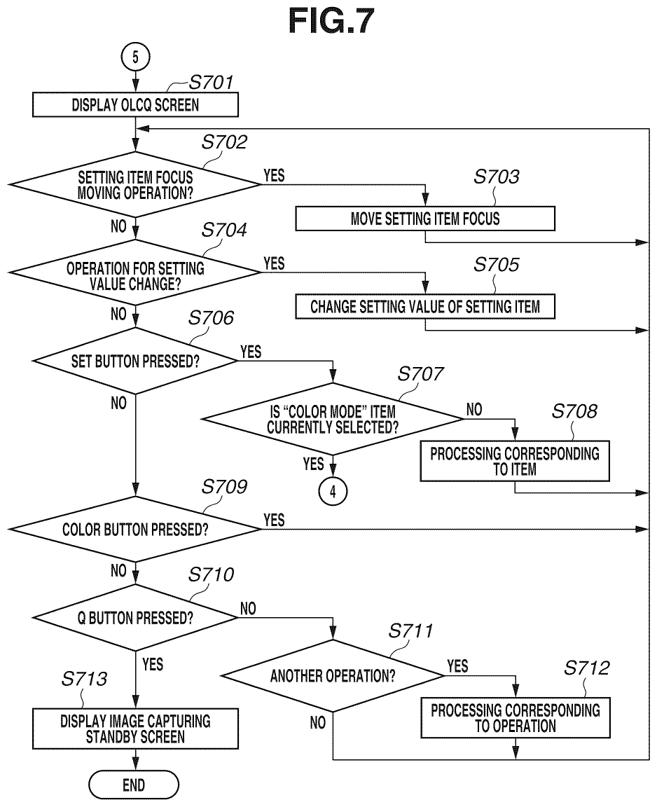

In step S400, the system control unit 50 sets the type of a screen serving as a transition source, which is the type of a screen obtained before the color mode selection screen is displayed, and stores the set type of a screen serving as a transition source in the system memory 52. In a case where the result of determination in step S305 is yes and the color mode selection screen display processing is performed in step S306, the type of a screen serving as a transition source is set as the image capturing standby screen 1000. In a case where the result of determination in step S506 illustrated in FIG. 5 is yes and the color mode selection screen display processing is performed, the type of a screen serving as a transition source is set as the menu screen 1200. Moreover, in a case where the result of determination in step S609 illustrated in FIG. 6 is yes and the color mode selection screen display processing is performed, the type of a screen serving as a transition source is set as the LVQ screen 1300. Moreover, in a case where the result of determination in step S707 illustrated in FIG. 7 is yes and the color mode selection screen display processing is performed, the type of a screen serving as a transition source is set as the OLCQ screen 1400.

In step S401, the system control unit 50 determines whether the type of a screen serving as a transition source stored in the system memory 52 is the LVQ screen 1300 included in the quick setting screens for the time of image capturing, and, if the result of determination is yes (YES in step S401), the system control unit 50 advances the processing to step S402 and, if the result of determination is no (NO in step S401), the system control unit 50 advances the processing to step S403.

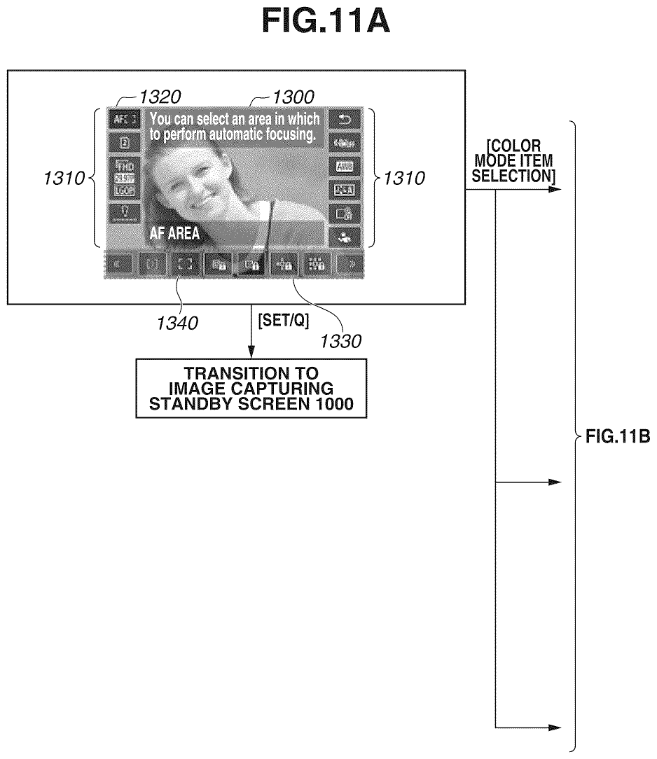

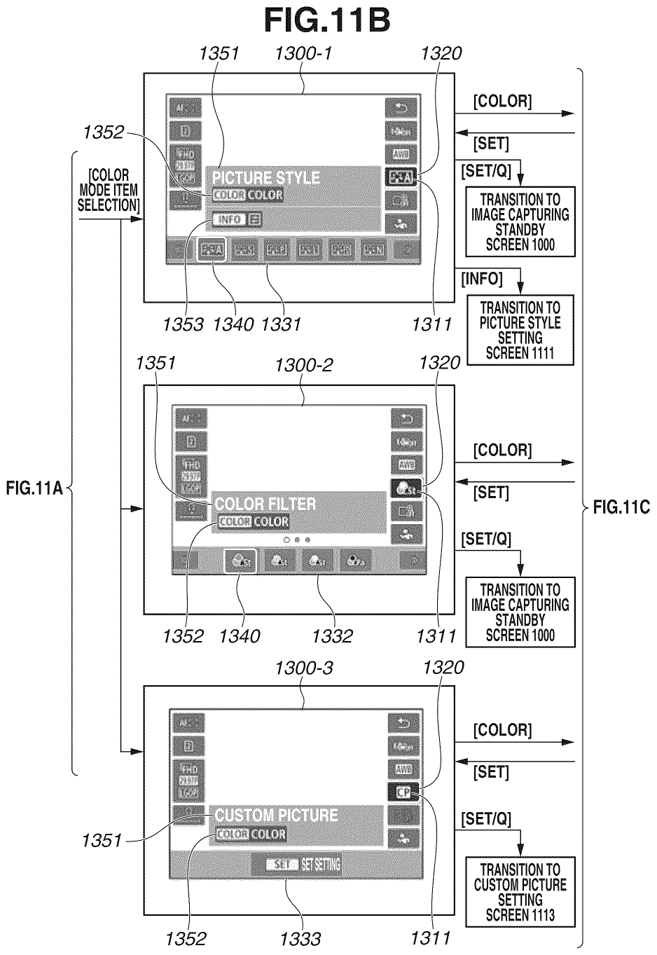

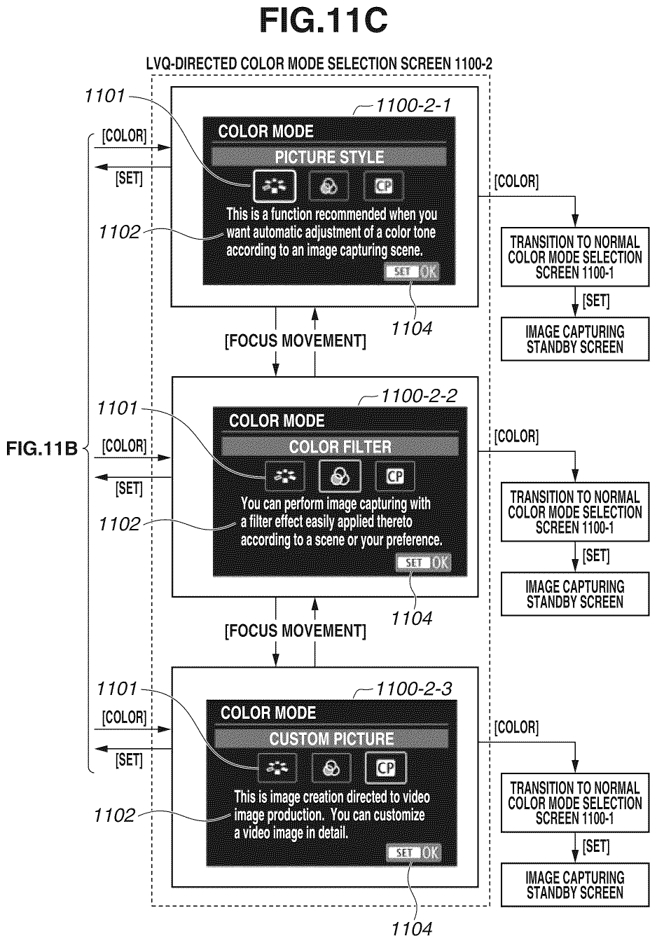

In step S402, the system control unit 50 displays an LVQ-directed color mode selection screen 1100-2 such as that illustrated in FIGS. 11A to 11C on the display unit 28, and then advances the processing to step S404.

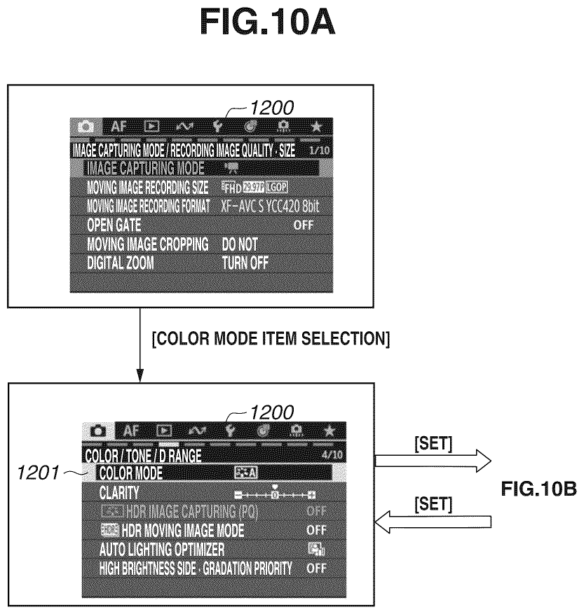

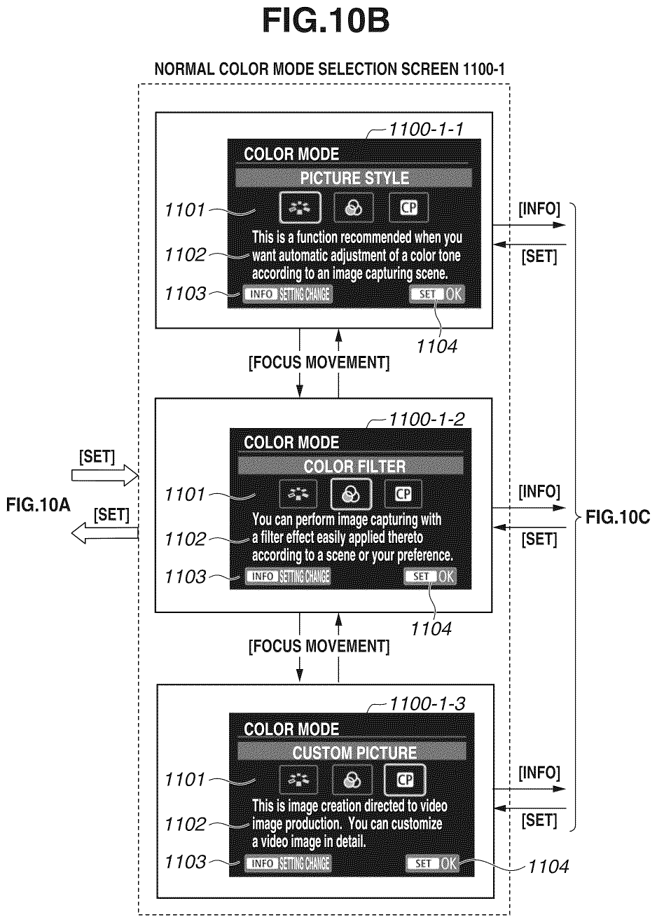

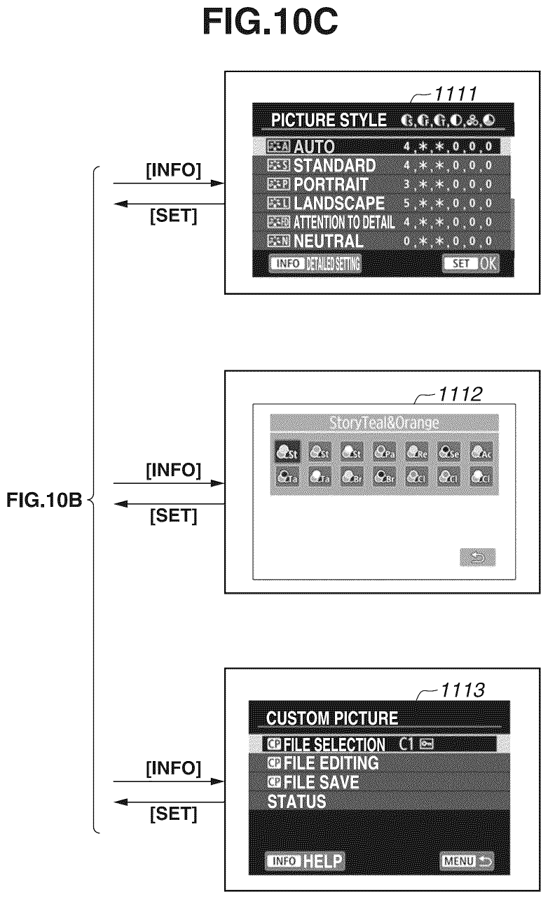

In step S403, the system control unit 50 displays a normal color mode selection screen 1100-1 such as that illustrated in FIGS. 10A, 10B, and 10C on the display unit 28, and then advances the processing to step S404.

As the color mode selection screen 1100 in the embodiment, the normal color mode selection screen 1100-1 illustrated in FIGS. 10A to 10C and the LVQ-directed color mode selection screen 1100-2 illustrated in FIGS. 11A to 11C are prepared. In the color mode selection screen 1100, icons 1101 representing respective three functions which are settable as color modes are displayed, and one of the icons 1101 is displayed in the state of being focused thereon as a currently selected function. Moreover, separately from a focus indicating the function in the process of being selected, an icon representing a function which is set as the current color mode can be displayed in a color different from those of the other icons. Moreover, below the icons 1101 used for function selection, explanatory text 1102 of the currently selected function is displayed. Additionally, in the color mode selection screen 1100, a [SET] OK icon 1104 is displayed. The [SET] OK icon 1104 indicates that pressing of the SET button 75 or a touch operation performed on the [SET] OK icon 1104 causes the currently selected function to be set as a color mode. In both the normal color mode selection screen 1100-1 and the LVQ-directed color mode selection screen 1100-2, the icons 1101 used for function selection, the explanatory text 1102 of the currently selected function, and the [SET] OK icon 1104 are displayed. Therefore, it is possible for the user to select a function to be set as the color mode and set the selected function. On the other hand, in the normal color mode selection screen 1100-1, an [INFO] setting change icon 1103 is displayed, but is not displayed in the LVQ-directed color mode selection screen 1100-2. The [INFO] setting change icon 1103 indicates that pressing of the INFO button 85 or a touch operation on the [INFO] setting change icon 1103 causes a setting screen for changing the setting values of the currently selected function to be indicated and causes the current displayed screen to transition to a setting screen corresponding to the currently selected function. Therefore, the normal color mode selection screen 1100-1 is able to transition to the setting screen for changing the setting values of the currently selected function, but the LVQ-directed color mode selection screen 1100-2 is not able to transition to such a setting screen even if the user operates the INFO button 85. Furthermore, while, in FIGS. 11A to 11C, the background of the LVQ-directed color mode selection screen 1100-2 is made black, the LVQ-directed color mode selection screen 1100-2 can be configured in such a manner that the icons 1101 used for function selection, the explanatory text 1102, and the [SET] OK icon 1104 are displayed in superimposition on a live view image. Since the LVQ screen 1300 is a screen in which setting items and selection items are displayed in superimposition on a live view image, setting the background of the LVQ-directed color mode selection screen 1100-2 as a live view image causes the live view image to be continuously displayed. In a case where, in this state, the Q button 84 has been pressed, the displayed screen returns to the LVQ screen 1300, and, therefore, even if the displayed screen transitions in the order of the LVQ screen 1300→the LVQ-directed color mode selection screen 1100-2→LVQ screen 1300 in this order, the live view image becomes continued to be displayed, so that it is possible to perform screen transition without providing a feeling of strangeness.

In step S404, the system control unit 50 determines whether the SET button 75 has been pressed or whether a touch operation on the [SET] OK icon 1104 has been performed, and if the SET button 75 has been pressed (YES in step S404), the system control unit 50 advances the processing to step S405 and, if the SET button 75 has not been pressed (NO in step S404), the system control unit 50 advances the processing to step S407. Then, in step S405, the system control unit 50 determines the currently selected function with a focus applied thereto as the setting of a color mode, stores the determined setting of a color mode in the non-volatile memory 56, and then advances the processing to step S406. In step S406, the system control unit 50 reads out information about the type of a screen serving as a transition source stored in step S400 from the system memory 52 and thus determines the type of a screen serving as a transition source. If the type of a screen serving as a transition source is the image capturing standby screen 1000 (IMAGE CAPTURING STANDBY SCREEN in step S406), the system control unit 50 advances the processing to step S302, thus performing display processing for the image capturing standby screen 1000. If the type of a screen serving as a transition source is the menu screen 1200 (MENU SCREEN in step S406), the system control unit 50 advances the processing to step S501, thus performing display processing for the menu screen 1200. If the type of a screen serving as a transition source is the LVQ screen 1300 (LVQ SCREEN in step S406), the system control unit 50 advances the processing to step S603, thus performing display processing for the LVQ screen 1300. If the type of a screen serving as a transition source is the OLCQ screen 1400 (OLCQ SCREEN in step S406), the system control unit 50 advances the processing to step S701, thus performing display processing for the OLCQ screen 1400. In this way, in a case where the SET button 75 has been operated when the color mode selection screen 1100 is being displayed, the system control unit 50 changes the setting of a color mode and switches displaying from the color mode selection screen 1100 to a screen selected as a transition source.

In step S407, the system control unit 50 determines whether a focus moving operation has been performed by the user via, for example, the arrow keys 74, the main electronic dial 71, the sub-electronic dial 73, or the touch panel 70a. If it is determined that the focus moving operation has been performed (YES in step S407), the system control unit 50 advances the processing to step S408 and, if it is determined that the focus moving operation has not been performed (NO in step S407), the system control unit 50 advances the processing to step S409. In step S408, the system control unit 50 switches an icon with a focus displayed thereon, from among the icons 1101 used for function selection in the color mode selection screen 1100, thus switching a function becoming currently selected from among a plurality of functions, and also updates displaying of the explanatory text 1102. In the case of the normal color mode selection screen 1100-1, the focus moving operation enables switching to any one of a screen 1100-1-1 in which the picture style function is currently selected, a screen 1100-1-2 in which the color filter function is currently selected, and a screen 1100-1-3 in which the custom picture function is currently selected. In response to the currently selected function being changed by the focus moving operation, the explanatory text 1102 is also changed to explanatory text corresponding to the changed currently selected function. In the case of the LVQ-directed color mode selection screen 1100-2, similarly, the focus moving operation also enables switching to any one of a screen 1100-2-1 in which the picture style function is currently selected, a screen 1100-2-2 in which the color filter function is currently selected, and a screen 1100-2-3 in which the custom picture function is currently selected. After the focus moving operation in step S408, the system control unit 50 returns the processing to step S404.

In step S409, the system control unit 50 determines whether the INFO button 85 has been pressed (or whether a touch operation on the [INFO] setting change icon 1103 has been performed). If it is determined that the INFO button 85 has been pressed (YES in step S409), the system control unit 50 advances the processing to step S410, and, if it is determined that the INFO button 85 has not been pressed (NO in step S409), the system control unit 50 advances the processing to step S411. In step S410, the system control unit 50 determines whether the currently displayed color mode selection screen 1100 is the normal color mode selection screen 1100-1 or the LVQ-directed color mode selection screen 1100-2. Thus, the system control unit 50 determines whether the currently displayed color mode selection screen 1100 is a screen in which the [INFO] setting change icon 1103 is currently displayed. If it is determined that the currently displayed color mode selection screen 1100 is the LVQ-directed color mode selection screen 1100-2, in which the [INFO] setting change icon 1103 is not displayed, (NO in step S410), the system control unit 50 returns the processing to step S404 without doing anything. If it is determined that the currently displayed color mode selection screen 1100 is the normal color mode selection screen 1100-1, in which the [INFO] setting change icon 1103 is displayed, (YES in step S410), the system control unit 50 advances the processing to step S421 to perform display processing for the setting screen for changing the setting values of the currently selected mode.

In step S411, the system control unit 50 determines whether the COLOR button 83 has been pressed, and, if it is determined that the COLOR button 83 has been pressed (YES in step S411), the system control unit 50 advances the processing to step S412 and, if it is determined that the COLOR button 83 has not been pressed (NO in step S411), the system control unit 50 returns the processing to step S404.

In step S412, the system control unit 50 determines whether the type of the screen serving as a transition source stored in the system memory 52 is the menu screen 1200. If it is determined that the screen serving as a transition source is the menu screen 1200 (YES in step S412), to avoid a complicated screen transition in the menu screen 1200, the system control unit 50 returns the processing to step S404 without doing anything. If it is determined that the screen serving as a transition source is not the menu screen 1200 (NO in step S412), the system control unit 50 advances the processing to step S413. In step S413, the system control unit 50 changes information about the type of the screen serving as a transition source stored in the system memory 52 to the image capturing standby screen 1000, and then returns the processing to step S403 to perform display processing for the normal color mode selection screen 1100-1. With such processing performed, for example, in a case where the COLOR button 83 has been pressed when the LVQ-directed color mode selection screen 1100-2 is being displayed, the normal color mode selection screen 1100-1 is displayed. Therefore, operating the INFO button 85 enables transitioning to the setting screen (1111, 1112, or 1113) for changing the setting values of the function. After the user operates the SET button 75 in the color mode selection screen 1100 to set the function and setting values of the color mode, to enable the user to immediately start image capturing by transitioning to the image capturing standby screen 1000 without displaying the other setting screens, the screen serving as a transition source is changed to the image capturing standby screen 1000. Moreover, a configuration in which, in a case where the normal color mode selection screen 1100-1 is displayed in response to the COLOR button 83 being pressed, the selected state obtained before the COLOR button 83 is operated is reset and a focus is displayed with respect to the function currently set as the color mode can be employed.

In step S421, the system control unit 50 determines whether the picture style function is currently selected in the normal color mode selection screen 1100-1. If it is determined that the picture style function is currently selected (YES in step S421), the system control unit 50 advances the processing to step S422. If not so (NO in step S421), the system control unit 50 advances the processing to step S426. In step S422, the system control unit 50 displays a picture style setting screen 1111 on the display unit 28. Thus, as illustrated in FIGS. 10A to 10C, in response to the INFO button 85 being pressed when the normal color mode selection screen 1100-1-1 in which the picture style function is currently selected is currently displayed, the normal color mode selection screen 1100-1-1 transitions to the picture style setting screen 1111. In the picture style setting screen 1111, for example, auto, standard, portrait, landscape, and attention to detail are able to be set as image capturing scenes or image capturing styles, and a plurality of selection items corresponding to the respective setting values which are able to be set is displayed. A focus is displayed at a selection item corresponding to the currently set setting value, and settings are able to be changed by the focus being moved by the user operation.

In step S423, the system control unit 50 determines whether an operation for setting change has been performed with, for example, the arrow keys 74, the main electronic dial 71, the sub-electronic dial 73, or the touch panel 70a. If it is determined that the operation for setting change has been performed (YES in step S423), the system control unit 50 advances the processing to step S424, and, if not so (NO in step S423), the system control unit 50 advances the processing to step S425. In step S424, the system control unit 50 moves the focus display according to the operation performed in step S423, sets the setting value corresponding to the selected selection item as a setting value of the picture style function, and stores the set setting value in the non-volatile memory 56.

In step S425, the system control unit 50 determines whether the SET button 75 has been pressed or a touch operation on an OK icon has been performed in the picture style setting screen 1111. If it is determined that such an operation has been performed (YES in step S425), the system control unit 50 ends displaying of the picture style setting screen 1111 and advances the processing to step S403, thus performing switching to displaying of the normal color mode selection screen 1100-1. At this time, to retrieve displaying of the color mode selection screen obtained before transitioning to the picture style setting screen 1111, the system control unit 50 is configured to display the normal color mode selection screen 1100-1-1 in which the picture style function is currently selected.

In step S426, the system control unit 50 determines whether the color filter function is currently selected in the normal color mode selection screen 1100-1. If it is determined that the color filter function is currently selected (YES in step S426), the system control unit 50 advances the processing to step S427. If not so (NO in step S426), the system control unit 50 determines that the custom picture function is currently selected and then advances the processing to step S431. In step S427, the system control unit 50 displays a color filter setting screen 1112 on the display unit 28. Thus, as illustrated in FIGS. 10A to 10C, in response to the INFO button 85 being pressed when the normal color mode selection screen 1100-1-2 in which the color filter function is currently selected is currently displayed, the normal color mode selection screen 1100-1-2 transitions to the color filter setting screen 1112. In the color filter setting screen 1112, selection items corresponding to a plurality of color filter effects, such as “StoryTeal&Orange”, “StoryMagenta”, and “StoryBlue”, are displayed. A focus is displayed at a selection item corresponding to the currently set setting value, and settings are able to be changed by the focus being moved by the user operation. Moreover, in the color filter setting screen 1112, these selection items are displayed in superimposition on a live view image, and a live view image subjected to the filter effect changed by the setting change operation is displayed on the display unit 28.

In step S428, the system control unit 50 determines whether an operation for setting change has been performed with, for example, the arrow keys 74, the main electronic dial 71, the sub-electronic dial 73, or the touch panel 70a. If it is determined that the operation for setting change has been performed (YES in step S428), the system control unit 50 advances the processing to step S429, and, if not so (NO in step S428), the system control unit 50 advances the processing to step S430. In step S429, the system control unit 50 moves the focus display according to the operation performed in step S428, sets the setting value corresponding to the selected selection item as a setting value of the color filter function, and stores the set setting value in the non-volatile memory 56.

In step S430, the system control unit 50 determines whether the SET button 75 has been pressed or a touch operation on a back icon has been performed in the color filter setting screen 1112. If it is determined that such an operation has been performed (YES in step S430), the system control unit 50 ends displaying of the color filter setting screen 1112 and advances the processing to step S403, thus performing switching to displaying of the normal color mode selection screen 1100-1. At this time, to retrieve displaying of the color mode selection screen obtained before transitioning to the color filter setting screen 1112, the system control unit 50 is configured to display the normal color mode selection screen 1100-1-2 in which the color filter function is currently selected.

In step S431, the system control unit 50 displays a custom picture setting screen 1113 on the display unit 28. Thus, as illustrated in FIGS. 10A to 10C, in response to the INFO button 85 being pressed when the normal color mode selection screen 1100-1-3 in which the custom picture function is currently selected is currently displayed, the normal color mode selection screen 1100-1-3 transitions to the custom picture setting screen 1113. In the custom picture setting screen 1113, the user is able to select and set a custom picture. Moreover, the user is able to edit or store a custom picture file.

In step S432, the system control unit 50 determines whether an operation for setting change has been performed with, for example, the arrow keys 74, the main electronic dial 71, the sub-electronic dial 73, or the touch panel 70a. If it is determined that the operation for setting change has been performed (YES in step S432), the system control unit 50 advances the processing to step S433, and, if not so (NO in step S432), the system control unit 50 advances the processing to step S434. In step S433, the system control unit 50 performs changing of settings of the custom picture file according to the operation performed in step S432, and stores the changed settings in the non-volatile memory 56.

In step S434, the system control unit 50 determines whether the SET button 75 has been pressed or a touch operation on a back icon has been performed in the custom picture setting screen 1113. If it is determined that such an operation has been performed (YES in step S434), the system control unit 50 ends displaying of the custom picture setting screen 1113 and advances the processing to step S403, thus performing switching to displaying of the normal color mode selection screen 1100-1. At this time, to retrieve displaying of the color mode selection screen obtained before transitioning to the custom picture setting screen 1113, the system control unit 50 is configured to display the normal color mode selection screen 1100-1-3 in which the custom picture function is currently selected.

Next, the details of the menu screen display processing are described with reference to FIG. 5.

In step S501, the system control unit 50 displays a menu screen 1200 such as that illustrated in FIGS. 10A to 10C, and then advances the processing to step S502. The menu screen 1200 contains a plurality of setting items, and the plurality of setting items includes a setting item 1201 for color mode. In the menu screen 1200, a focus (selection frame) is displayed with respect to a setting item which is currently selected, and the focus is able to move to another setting item by an operation on, for example, the arrow keys 74, the main electronic dial 71, the sub-electronic dial 73, or the touch panel 70a. In a case where the menu screen 1200 is composed of a plurality of pages or a plurality of tabs, the movement of the focus includes the movement of a page or the movement of a tab.

In step S502, the system control unit 50 determines whether the menu button 81 has been pressed, and, if it is determined that the menu button 81 has been pressed (YES in step S502), the system control unit 50 advances the processing to step S511 and, if not so (NO in step S502), the system control unit 50 advances the processing to step S503. In step S511, the system control unit 50 ends displaying of the menu screen 1200 and displays the image capturing standby screen 1000, ends the processing illustrated in FIG. 5, and then returns the processing to step S303 illustrated in FIG. 3.

In step S503, the system control unit 50 determines whether the focus moving operation by the user has been performed, and, if the result of determination is yes (YES in step S503), the system control unit 50 advances the processing to step S504 and, if the result of determination is no (NO in step S503), the system control unit 50 advances the processing to step S505. In step S504, the system control unit 50 changes a setting item of the menu to be focused (subjected to selection frame displaying), and then returns the processing to step S502.

In step S505, the system control unit 50 determines whether the SET button 75 has been pressed, and, if it is determined that the SET button 75 has been pressed (YES in step S505), the system control unit 50 advances the processing to step S506 and, if it is determined that the SET button 75 has not been pressed (NO in step S505), the system control unit 50 advances the processing to step S508. An operation on the SET button 75 enables fixing the selection of a setting item which is currently selected with the focus and issuing an instruction for performing processing on the currently selected setting item. In the case of a touch operation, a touch operation on a setting item can be used to simultaneously perform movement of the focus and fixing of a selection corresponding to an operation on the SET button 75.

In step S506, the system control unit 50 determines whether the setting item in the menu which is subjected to the focus (is currently selected) is “color mode”. If it is determined that the menu setting item which is currently selected is not “color mode” (NO in step S506), the system control unit 50 advances the processing to step S507. If it is determined that the menu setting item which is currently selected is “color mode” (YES in step S506), the system control unit 50 advances the processing to the color mode selection screen display processing illustrated in FIGS. 4A and 4B. As illustrated in FIGS. 10A to 10C, in a case where, in response to the COLOR button 83 being pressed in the menu screen 1200 in which the “color mode” item is currently selected, the menu screen 1200 transitions to the color mode selection screen 1100, the screen serving as a transition source is the menu screen 1200. Therefore, in step S403, display processing for the normal color mode selection screen 1100-1 is performed. Then, the menu screen 1200 transitions to the normal color mode selection screen 1100-1, and, in a case where the SET button 75 has been pressed in the normal color mode selection screen 1100-1, the normal color mode selection screen 1100-1 returns to the menu screen 1200 (step S404, step S406, and step S501). Here, when returning to the menu screen 1200, the normal color mode selection screen 1100-1 returns the menu screen 1200 in which a focus is displayed at the “color mode” item.

In step S507, the system control unit 50 performs processing corresponding to the currently focused menu setting item, and then returns the processing to step S502. The processing corresponding to the menu setting item is processing for, for example, changing of a setting value.

In step S508, the system control unit 50 determines whether the COLOR button 83 has been pressed. If it is determined that the COLOR button 83 has been pressed (YES in step S508), to avoid a complicated screen transition occurring, the system control unit 50 returns the processing to step S502 without processing anything, and, if it is determined that the COLOR button 83 has not been pressed (NO in step S508), the system control unit 50 advances the processing to step S509.

In step S509, the system control unit 50 determines whether another operation has been performed on the operation unit 70, and, if it is determined that another operation has been performed (YES in step S509), the system control unit 50 advances the processing to step S510. If it is determined that no other operation has been performed (NO in step S509), the system control unit 50 returns the processing to step S502, thus repeatedly performing determination of operations.

In step S510, the system control unit 50 performs processing corresponding to the operation performed in step S509, and then returns the processing to step S502.

In this way, in the menu screen 1200, in response to the user selecting a setting item for the color mode and fixing selection of the setting item by the SET button 75, the menu screen 1200 transitions to the normal color mode selection screen 1100-1. After transition to the normal color mode selection screen 1100-1, the user is able to set the function to be executed as color mode, as described above with reference to FIGS. 4A and 4B. Moreover, by operating the INFO button 85 in the normal color mode selection screen 1100-1, the user is also able to cause the normal color mode selection screen 1100-1 to transition to a setting screen for changing a setting value for the selected color mode function and change the setting value.

The details of the quick setting screen display processing for the time of image capturing are described with reference to FIG. 6 to FIG. 8.

The camera 100 in the embodiment has, as a quick setting screen for the time of image capturing, three types of setting screens, i.e., the LVQ screen 1300, the OLCQ screen 1400, and the cinema Q screen 1500, in each of which a screen corresponding to the display state of the image capturing standby screen 1000 or the display setting of the quick setting screen is displayed. The display setting of the quick setting screen is able to be changed via the menu screen 1200.

In step S601, the system control unit 50 determines whether the image capturing standby screen 1000 is in the live view display state, and, if the result of determination is yes (YES in step S601), the system control unit 50 advances the processing to step S602 and, if the result of determination is no (NO in step S601), the system control unit 50 advances the processing to step S701 to perform display processing for the OLCQ screen 1400, which is a control panel-like quick setting screen. In step S602, the system control unit 50 determines whether the display setting of the quick setting screen is set to cinema-like display. If it is determined that cinema-like display is currently set (YES in step S602), the system control unit 50 advances the processing to step S801 to perform display processing for the cinema Q screen 1500, which is a cinema-like quick setting screen. If it is determined that the display setting of the quick setting screen is set to not cinema-like display but live view display (NO in step S602), the system control unit 50 advances the processing to step S603.

In step S603, the system control unit 50 displays, on the display unit 28, the LVQ screen 1300, in which the quick setting screen is displayed in superimposition on the live view image. In the LVQ screen 1300, a plurality of quick setting screens is displayed in superimposition on the live view image. At the left and right end portions of the LVQ screen 1300, a plurality of setting items 1310 respectively corresponding to the plurality of quick setting screens is displayed. A setting item focus 1320 is displayed with respect to one currently selected item out of the plurality of setting items 1310. A plurality of selection items 1330 corresponding to setting values which are able to be set for the setting item currently selected with the setting item focus 1320 is displayed at the lower end of the LVQ screen 1300. A setting value focus 1340 is displayed with respect to a selection item corresponding to the currently set setting value out of the selection items 1330. Furthermore, in the selection items 1330, icons indicating respective setting values thereof are displayed. Then, in the plurality of setting items 1310, icons indicating setting values which are set with respect to the respective setting items are displayed. A setting item 1311 corresponding to the color mode is included in the plurality of setting items 1310.

In step S604, the system control unit 50 determines whether, in the LVQ screen 1300, the moving operation for the setting item focus 1320 has been performed by the user. If it is determined that the moving operation for the setting item focus 1320 has been performed (YES in step S604), the system control unit 50 advances the processing to step S605 and, if it is determined that the moving operation for the setting item focus 1320 has not been performed (NO in step S604), the system control unit 50 advances the processing to step S606.

In step S605, the system control unit 50 moves the setting item focus 1320 to a setting item corresponding to the operation performed in step S604. Then, according to the moving operation for the setting item focus 1320, the system control unit 50 changes the selection items 1330 to selection items corresponding to setting values of the selected setting item and displays the changed selection items 1330. For example, in a case where, as illustrated in FIGS. 11A to 11C, a setting item for autofocus (AF) area located at the upper left corner is selected and the setting item focus 1320 is displayed at the selected setting item, selection items 1330 being icons corresponding to the respective setting values, such as spot one-point AF, one-point AF, area expansion AF, and flexible zone AF, which are settable as AF area settings are displayed.

Moreover, in the setting item 1311 corresponding to the color mode, an icon corresponding to the setting value of a function currently set in the color mode setting is displayed. In a case where the setting of the color mode has been changed in the color mode selection screen 1100, the function currently set in the color mode setting becomes a function which has been set in the color mode selection screen 1100, and, in a case where the setting of the color mode has not been changed, the function currently set in the color mode setting becomes a function which has been set as an initial setting of the camera 100.

In a case where the picture style is currently set as the color mode, a screen such as an LVQ screen 1300-1 is displayed. In the setting item 1311 for the color mode, an icon corresponding to a setting value currently set in the picture style function is displayed. Then, in response to the setting item 1311 for the color mode being selected and the setting item focus 1320 being displayed thereon, icons 1331 corresponding to setting values which are able to be set in the picture style function are displayed as the selection items 1330. Thus, after the setting item 1311 for the color mode is selected, without the setting of the color mode being performed in the color mode selection screen 1100, the selection items 1330 (icons 1331) for changing the setting value of a function set in the color mode are displayed. Moreover, in the LVQ screen 1300-1, “Picture style” is displayed as a setting function name 1351 indicating the setting of the current color mode. Additionally, a COLOR icon 1352, which indicates that the setting of the color mode is able to be changed by an operation on the COLOR button 83, and an INFO icon 1353, which indicates that the detailed setting of setting values of the picture style is able to be performed by an operation on the INFO button 85, are displayed.

In a case where the color filter is currently set as the color mode, a screen such as an LVQ screen 1300-2 is displayed. In the setting item 1311 for the color mode, an icon corresponding to a setting value currently set in the color filter function is displayed. Then, in response to the setting item 1311 for the color mode being selected and the setting item focus 1320 being displayed thereon, icons 1332 corresponding to setting values which are able to be set in the color filter function are displayed as the selection items 1330. Thus, after the setting item 1311 for the color mode is selected, without the setting of the color mode being performed in the color mode selection screen 1100, the selection items 1330 (icons 1332) for changing the setting value of a function set in the color mode are displayed. Moreover, in the LVQ screen 1300-2, “Color filter” is displayed as a setting function name 1351 indicating the setting of the current color mode, and the COLOR icon 1352 is also displayed.

In a case where the custom picture is currently set as the color mode, a screen such as an LVQ screen 1300-3 is displayed. In the setting item 1311 for the color mode, an icon indicating that the custom picture function is currently selected is displayed. In the LVQ screen 1300-3, “Custom picture” is displayed as a setting function name 1351 indicating the setting of the current color mode, and the COLOR icon 1352 is also displayed. Then, in a case where the setting item 1311 for the color mode is selected and the setting item focus 1320 is displayed thereon, a “SET” setting icon 1333 is displayed as the selection item 1330. Since the custom picture allows setting of, for example, selection and editing of a custom picture file, setting values thereof are able to be changed only via the custom picture setting screen 1113. Therefore, an icon indicating that these settings are able to be performed by pressing of the SET button 75, i.e., the “SET” setting icon 1333, is displayed. Furthermore, a configuration in which a touch operation on the “SET” setting icon 1333 causes the LVQ screen 1300-3 to transition to the custom picture setting screen 1113 can be employed.

After performing the processing operation in step S605, the system control unit 50 returns the processing to step S604.

In step S606, the system control unit 50 determines whether the moving operation for the setting value focus 1340 has been performed. If it is determined that the moving operation for the setting value focus 1340 has been performed (YES in step S606), the system control unit 50 advances the processing to step S607, and, if not so (NO in step S606), the system control unit 50 advances the processing to step S608.

In step S607, the system control unit 50 moves the setting value focus 1340 according to an operation performed in step S606, and stores, in the non-volatile memory 56, a setting value corresponding to the newly selected selection item as a setting value of the setting item currently selected with the setting item focus 1320. After that, the system control unit 50 returns the processing to step S604.

In step S608, the system control unit 50 determines whether the COLOR button 83 has been pressed, and, if it is determined that the COLOR button 83 has been pressed (YES in step S608), the system control unit 50 advances the processing to step S609 and, if it is determined that the COLOR button 83 has not been pressed (NO in step S608), the system control unit 50 advances the processing to step S610.

In step S609, the system control unit 50 determines whether the setting item 1311 for the color mode is currently selected with the setting item focus 1320. If it is determined that the setting item 1311 for the color mode is currently selected (YES in step S609), the system control unit 50 advances the processing to the color mode selection screen display processing in step S400 illustrated in FIG. 4A. In this case, the screen serving as a transition source becomes the LVQ screen 1300. Therefore, in response to the processing operation in step S402, the LVQ-directed color mode selection screen 1100-2 is displayed. Thus, according to the currently set color mode, any one of the LVQ-directed color mode selection screens 1100-2-1, 1100-2-2, and 1100-2-3 is displayed.

If, in step S609, it is determined that the setting item 1311 for the color mode is not currently selected (NO in step S609), the system control unit 50 returns the processing to step S604 without performing any processing. Here, to avoid a complicated screen transition and to prevent an erroneous operation, in a case where the setting item 1311 for the color mode is not currently selected, even if the COLOR button 83 is operated, the system control unit 50 does not perform any processing.

In step S610, the system control unit 50 determines whether the INFO button 85 has been pressed, and, if it is determined that the INFO button 85 has been pressed (YES in step S610), the system control unit 50 advances the processing to step S611 and, if it is determined that the INFO button 85 has not been pressed (NO in step S610), the system control unit 50 advances the processing to step S613.

In step S611, the system control unit 50 determines whether the setting item 1311 for the color mode is currently selected with the setting item focus 1320 and the picture style is currently set to the color mode. In a case where the setting item 1311 for the color mode is currently selected and the picture style is currently set to the color mode, as in the LVQ screen 1300-1 illustrated in FIGS. 11A to 11C, the INFO icon 1353 is displayed and the picture style setting screen display function is allocated to the INFO button 85. Therefore, if the INFO button 85 is operated in such a state (YES in step S610 and YES in step S611), the system control unit 50 advances the processing to step S422 illustrated in FIG. 4B and performs display processing for the picture style setting screen 1111. If the INFO button 85 is operated in the other states (YES in step S610 and NO in step S611), then in step S612, the system control unit 50 performs processing which is allocated to the INFO button 85 at that point of time, and then returns the processing to step S604.

In step S613, the system control unit 50 determines whether the SET button 75 has been pressed, and, if it is determined that the SET button 75 has been pressed (YES in step S613), the system control unit 50 advances the processing to step S614 and, if it is determined that the SET button 75 has not been pressed (NO in step S613), the system control unit 50 advances the processing to step S615.

In step S614, the system control unit 50 determines whether the setting item 1311 for the color mode is currently selected with the setting item focus 1320 and the custom picture is currently set to the color mode. Normally, to the SET button 75, the function of ending displaying of the LVQ screen 1300 and returning to displaying of the image capturing standby screen 1000 is allocated. However, in a case where the setting item 1311 for the color mode is currently selected and the custom picture is currently set to the color mode, as in the LVQ screen 1300-3 illustrated in FIGS. 11A to 11C, the “SET” setting icon 1333 is displayed and the custom picture setting screen display function is allocated to the SET button 75. Therefore, if the SET button 75 is operated in such a state (YES in step S613 and YES in step S614), the system control unit 50 advances the processing to step S431 illustrated in FIG. 4B and performs display processing for the custom picture setting screen 1113. If the SET button 75 is operated in the other states (YES in step S613 and NO in step S614), then in step S616, the system control unit 50 displays the image capturing standby screen 1000 on the display unit 28, ends the quick setting screen display processing for the time of image capturing, and then returns the processing to step S303 illustrated in FIG. 3.

In step S615, the system control unit 50 determines whether the Q button 84 has been pressed, and, if it is determined that the Q button 84 has been pressed (YES in step S615), the system control unit 50 advances the processing to step S616 and, if it is determined that the Q button 84 has not been pressed (NO in step S615), the system control unit 50 advances the processing to step S617. In a case where the Q button 84 has been pressed, then in step S616, the system control unit 50 ends displaying of the LVQ screen 1300 and returns the processing to displaying of the image capturing standby screen 1000.

In step S617, the system control unit 50 determines whether another operation has been performed on the operation unit 70, and, if it is determined that another operation has been performed (YES in step S617), the system control unit 50 advances the processing to step S618. If no other operation has been performed (NO in step S617), the system control unit 50 returns the processing to step S604 to repeatedly perform determination of operations.

In step S618, the system control unit 50 performs processing corresponding to the operation performed in step S617, and then returns the processing to step S604.

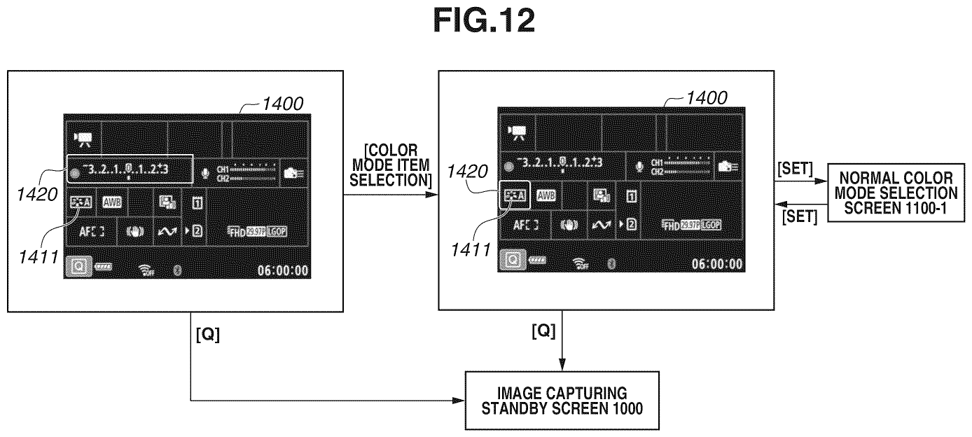

In step S701, the system control unit 50 displays the OLCQ screen 1400, which is a control panel-like quick setting screen, such as that illustrated in FIG. 12 on the display unit 28, and then advances the processing to step S702. In the OLCQ screen 1400, a plurality of setting items is displayed, but a live view image is not displayed. Moreover, as with the LVQ screen 1300, a setting item focus 1420 is displayed. Moreover, in the plurality of setting items which are displayed, a color mode setting item 1411 is included.

In step S702, the system control unit 50 determines whether the moving operation for the setting item focus 1420 has been performed by the user, and, if the result of determination is yes (YES in step S702), the system control unit 50 advances the processing to step S703 and, if the result of determination is no (NO in step S702), the system control unit 50 advances the processing to step S704.

In step S703, the system control unit 50 moves the setting item focus 1420 to another setting item according to the operation performed in step S702, displays the moved setting item focus 1420, and then returns the processing to step S702. The moving operation for the setting item focus 1420 enables changing the currently selected item from the color mode setting item 1411 to another item or from another item to the color mode setting item 1411.

In step S704, the system control unit 50 determines whether the changing operation for a setting value with respect to the setting item selected in step S703 has been performed, and, if the result of determination is yes (YES in step S704), the system control unit 50 advances the processing to step S705 and, if the result of determination is no (NO in step S704), the system control unit 50 advances the processing to step S706.

In step S705, the system control unit 50 changes the setting value of the setting item currently selected with the setting item focus 1420, displays the changed setting value, stores the changed setting value in the non-volatile memory 56, and then returns the processing to step S702.

In step S706, the system control unit 50 determines whether the SET button 75 has been pressed, and, if it is determined that the SET button 75 has been pressed (YES in step S706), the system control unit 50 advances the processing to step S707 and, if it is determined that the SET button 75 has not been pressed (NO in step S706), the system control unit 50 advances the processing to step S709.

In step S707, the system control unit 50 determines whether the setting item currently selected with the setting item focus 1420 is the color mode setting item 1411. If it is determined that the currently selected setting item is the color mode setting item 1411 (YES in step S707), the system control unit 50 advances the processing to the color mode selection screen display processing illustrated in FIGS. 4A and 4B. In this case, since the screen serving as a transition source becomes the OLCQ screen 1400, in step S403, the normal color mode selection screen 1100-1 is displayed. After the normal color mode selection screen 1100-1 is displayed, if, without the COLOR button 83 being operated, the SET button 75 is pressed when the normal color mode selection screen 1100-1 is being displayed, the normal color mode selection screen 1100-1 returns to the OLCQ screen 1400 (step S404→step S406→step S601). If, in step S707, it is determined that the currently selected setting item is not the color mode setting item 1411 (NO in step S707), then in step S708, the system control unit 50 performs processing corresponding to the currently selected setting item, and then returns the processing to step S702.

In step S709, the system control unit 50 determines whether the COLOR button 83 has been pressed, and, if it is determined that the COLOR button 83 has been pressed (YES in step S709), the system control unit 50 returns the processing to step S702 without processing anything and, if it is determined that the COLOR button 83 has not been pressed (NO in step S709), the system control unit 50 advances the processing to step S710.

In step S710, the system control unit 50 determines whether the Q button 84 has been pressed, and, if it is determined that the Q button 84 has been pressed (YES in step S710), the system control unit 50 advances the processing to step S713. If it is determined that the Q button 84 has not been pressed (NO in step S710), the system control unit 50 advances the processing to step S711. In step S713, the system control unit 50 displays the image capturing standby screen 1000, ends the quick setting screen display processing for the time of image capturing, and then returns the processing to step S303 illustrated in FIG. 3.

In step S711, the system control unit 50 determines whether another operation has been performed on the operation unit 70, and, if it is determined that another operation has been performed (YES in step S711), the system control unit 50 advances the processing to step S712. If it is determined that no other operation has been performed (NO in step S711), the system control unit 50 returns the processing to step S702, thus repeatedly performing determination of operations. In step S712, the system control unit 50 performs processing corresponding to the operation performed in step S711, and then returns the processing to step S702.

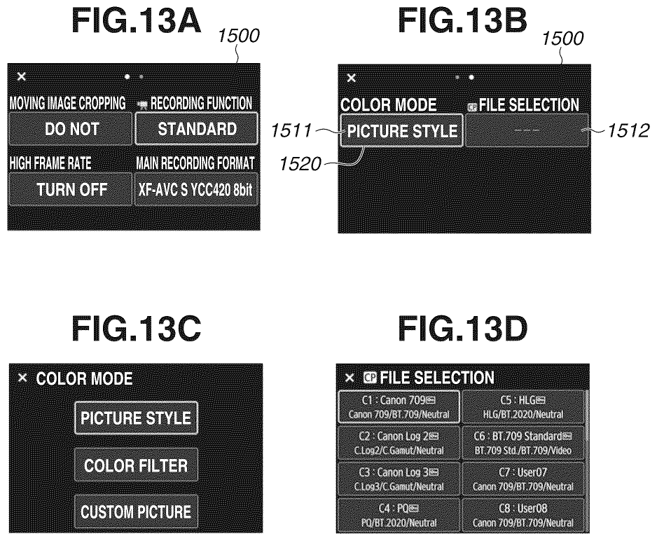

In step S801, the system control unit 50 displays a cinema Q screen 1500, such as those illustrated in FIGS. 13A, 13B, 13C, and 13D, on the display unit 28. The cinema Q screen 1500 is composed of a plurality of pages as illustrated in FIGS. 13A and 13B, and setting items are displayed in the respective pages. Moreover, as with the other setting screens, a setting item focus 1520 indicating a currently selected setting item is also displayed. As illustrated in FIG. 13B, in the setting items which are displayed, a setting item 1511 for the color mode is also included. Moreover, a selection 1512 for a custom picture file is displayed as a setting item.

In step S802, the system control unit 50 determines whether a page advancing operation has been performed by the user, and, if the result of determination is yes (YES in step S802), the system control unit 50 advances the processing to step S803 and, if the result of determination is no (NO in step S802), the system control unit 50 advances the processing to step S804.

In step S803, the system control unit 50 changes a page to be displayed, and then returns the processing to step S802.

In step S804, the system control unit 50 determines whether the moving operation for the setting item focus 1520 has been performed by the user, and, if the result of determination is yes (YES in step S804), the system control unit 50 advances the processing to step S805 and, if the result of determination is no (NO in step S804), the system control unit 50 advances the processing to step S806.

In step S805, the system control unit 50 moves the setting item focus 1520 to change the currently selected setting item, and then returns the processing to step S802.

In step S806, the system control unit 50 determines whether the SET button 75 has been pressed, and, if it is determined that the SET button 75 has been pressed (YES in step S806), the system control unit 50 advances the processing to step S807 and, if it is determined that the SET button 75 has not been pressed (NO in step S806), the system control unit 50 advances the processing to step S810.

In step S807, the system control unit 50 determines whether the menu setting item currently selected with the setting item focus 1520 is the color mode setting item 1511, and, if the result of determination is yes (YES in step S807), the system control unit 50 advances the processing to step S808 and, if the result of determination is no (NO in step S807), the system control unit 50 advances the processing to step S809.

In step S808, the system control unit 50 displays a cinema-like dedicated color mode selection screen illustrated in FIG. 13C and receives setting of the color mode. The cinema-like dedicated color mode selection screen is completely different in screen configuration from the normal color mode selection screen 1100-1 and the LVQ-directed color mode selection screen 1100-2 but is the same as those in that three functions which are settable as the color mode are displayed as options. However, the cinema-like dedicated color mode selection screen allows setting any one of the picture style, the color filter, and the custom picture as the color mode setting, but does not allow setting the setting values of the picture style and the color filter.

In step S809, the system control unit 50 performs processing corresponding to the menu setting item currently selected with the setting item focus 1520, and then returns the processing to step S802. The processing corresponding to the menu setting item includes, for example, processing for selecting the selection 1512 for a custom picture file, displaying a custom picture file selection screen illustrated in FIG. 13D, and selecting a file.

In step S810, the system control unit 50 determines whether the COLOR button 83 has been pressed, and, if it is determined that the COLOR button 83 has been pressed (YES in step S810), the system control unit 50 advances the processing to step S811 and, if it is determined that the COLOR button 83 has not been pressed (NO in step S810), the system control unit 50 advances the processing to step S812.

In step S811, the system control unit 50 determines whether the menu setting item currently selected with the setting item focus 1520 is the color mode setting item 1511, and, if the result of determination is yes (YES in step S811), the system control unit 50 advances the processing to the color mode selection screen display processing illustrated in FIGS. 4A and 4B and, if the result of determination is no (NO in step S811), the system control unit 50 returns the processing to step S802. Here, since, in a case where the processing has proceeded to the color mode selection screen display processing, the normal color mode selection screen 1100-1 is displayed, it becomes possible to set the setting values of the picture style and the color filter.

In step S812, the system control unit 50 determines whether the Q button 84 has been pressed, and, if it is determined that the Q button 84 has been pressed (YES in step S812), the system control unit 50 advances the processing to step S815. If it is determined that the Q button 84 has not been pressed (NO in step S812), the system control unit 50 advances the processing to step S813. In step S815, the system control unit 50 displays the image capturing standby screen 1000, ends the quick setting screen display processing for the time of image capturing, and then returns the processing to step S303 illustrated in FIG. 3.

In step S813, the system control unit 50 determines whether another operation has been performed on the operation unit 70, and, if it is determined that another operation has been performed (YES in step S813), the system control unit 50 advances the processing to step S814. If it is determined that no other operation has been performed (NO in step S813), the system control unit 50 returns the processing to step S802, thus repeatedly performing determination of operations. In step S814, the system control unit 50 performs processing corresponding to the operation performed in step S813, and then returns the processing to step S802.

In the above-described way, the camera 100 in the embodiment displays the color mode selection screen 1100 in response to the selection of a color mode setting item being determined by the SET button 75 or a touch operation in the menu screen 1200 or in response to the COLOR button 83 being pressed when the image capturing standby screen 1000 is being displayed. In this case, the camera 100 displays the normal color mode selection screen 1100-1 and then displays a setting screen corresponding to the currently selected color mode function in response to the INFO button 85 being pressed in the state in which the normal color mode selection screen 1100-1 is displayed, thus enabling setting the setting values of the currently selected color mode function. On the other hand, in the LVQ screen 1300, in which setting items are displayed in superimposition on a live view image, the camera 100 displays selection items for changing the setting values of the function currently set as the color mode, in response to the selection of a color mode setting item by the focus moving operation or a touch operation. Thus, in response to the selection of a color mode setting item, the camera 100 enables, without displaying the color mode selection screen 1100, changing the setting values of the function currently set as the color mode. In this state, the camera 100 displays the color mode selection screen 1100 in response to the COLOR button 83 being pressed, thus enabling changing the currently set color mode function which is displayed in the LVQ screen 1300. In the case of displaying the color mode selection screen 1100 from the LVQ screen 1300, since it is possible to change the setting values of the currently set color mode function in the LVQ screen 1300, the camera 100 displays the LVQ-directed color mode selection screen 1100-2, which is unable to transition to a setting screen for changing the setting values. However, a configuration in which, even in the case of transitioning from the LVQ screen 1300, the camera 100 displays the normal color mode selection screen 1100-1 can be employed. Alternatively, a configuration in which the camera 100 displays a normal color mode selection screen 1100-1 on which a live view image is superimposed as a background can be employed.

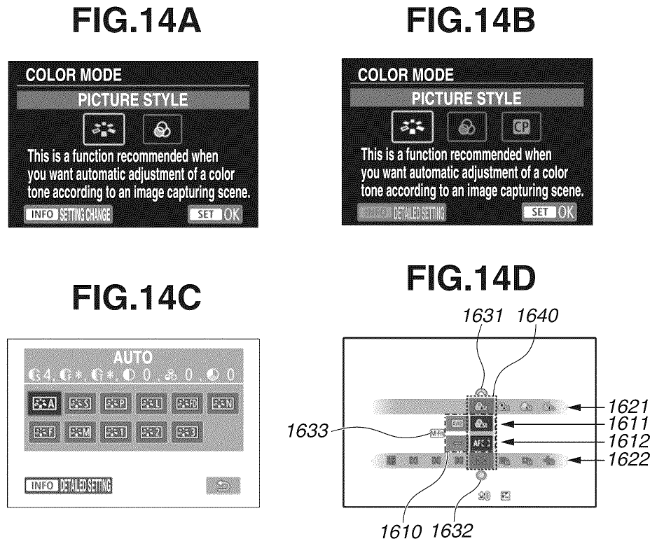

Moreover, in the above-described embodiment, a case where, as in the color mode selection screens 1100 illustrated in FIGS. 10A to 10C and FIGS. 11A to 11C, the user is allowed to select a function to be executed as the color mode from among three functions, i.e., the picture style function, the color filter function, and the custom picture function, has been described. However, a configuration in which, as in a color mode selection screen illustrated in FIG. 14A, the user is allowed to select a function for color mode from among two functions, i.e., the picture style function and the color filter function, can also be employed. Alternatively, functions which are able to be selected can be changed according to the image capturing mode. In the case of a still image capturing mode, the camera 100 can display a color mode selection screen such as that illustrated in FIG. 14A to allow the user to select a color mode from among two functions, and, in the case of a moving image capturing mode, the camera 100 can display a color mode selection screen such as those illustrated in FIGS. 10A to 10C and FIGS. 11A to 11C to allow the user to select a color mode from among three functions.

Moreover, in the LVQ-directed color mode selection screen 1100-2 illustrated in FIGS. 11A to 11C, the camera 100 hides the [INFO] setting change icon 1103, but can gray out the [INFO] setting change icon 1103 as illustrated in FIG. 14B to inform the user that the [INFO] setting change icon 1103 is unable to be operated.

Moreover, with regard to a picture style setting screen, instead of the picture style setting screen 1111 illustrated in FIGS. 10A to 10C being displayed, icons indicating respective setting values can be displayed in superimposition on a live view image as illustrated in FIG. 14C. Displaying a picture style setting screen such as that illustrated in FIG. 14C enables determining setting values while confirming a difference in image creation due to changing of the setting values. Moreover, in the case of displaying the picture style setting screen 1111 from the menu screen 1200 via the color mode selection screen 1100, the camera 100 can display a picture style setting screen 1111 such as that illustrated in FIGS. 10A to 10C which is similar in screen configuration to the menu screen 1200, and, in the case of displaying the picture style setting screen 1111 from the LVQ screen 1300 via the color mode selection screen 1100, the camera 100 can display a screen such as that illustrated in FIG. 14C.

Moreover, with regard to an LVQ screen, instead of the LVQ screen 1300 such as that illustrated in FIGS. 11A to 11C being displayed, a screen configuration such as that of a setting screen illustrated in FIG. 14D can be employed, or displaying of the LVQ screen 1300 and displaying of the setting screen illustrated in FIG. 14D can be switched according to the display mode. In the setting screen illustrated in FIG. 14D, a setting item group 1610, an upper-row selection item group 1621, a lower-row selection item group 1622, a main dial icon 1631, a sub-dial icon 1632, and a manual function (M-Fn) button icon 1633 are displayed. In a central area 1640, the currently selected setting item and selection item are displayed. The M-Fn button icon 1633 indicates that performing an operation on the M-Fn button 77 enables changing the selection of a setting item. In response to the M-Fn button 77 being operated, the display position of the setting item group 1610 is changed to the left or right, so that the currently selected setting item is displayed in the central area 1640. Moreover, the setting item group 1610 includes an upper-row setting item 1611 and a lower-row setting item 1612, and, in response to the M-Fn button 77 being operated, the selection of both the upper-row setting item 1611 and the lower-row setting item 1612 is changed at one time. In the respective setting items of the setting item group 1610, icons corresponding to setting values which are set for the respective setting items are displayed as with the LVQ screen 1300. In the upper-row selection item group 1621, setting values of the currently selected setting item included in the upper-row setting item 1611 are displayed as selection items. The main dial icon 1631 indicates that operating the main electronic dial 71 enables changing the selection of the upper-row selection item. In response to the main electronic dial 71 being operated, the camera 100 changes the display position of the upper-row selection item group 1621 to change the currently selected upper-row selection item and then sets setting values corresponding to the currently selected selection item as the currently selected upper-row setting item. In the lower-row selection item group 1622, setting values of the currently selected setting item included in the lower-row setting item 1612 are displayed as the selection item. The sub-dial icon 1632 indicates that operating the sub-electronic dial 73 enables changing the selection of the lower-row selection item. In response to the sub-electronic dial 73 being operated, the camera 100 changes the display position of the lower-row selection item group 1622 to change the currently selected lower-row selection item and then sets setting values corresponding to the currently selected selection item as the currently selected lower-row setting item. In a case where the COLOR button 83 has been pressed when the screen illustrated in FIG. 14C is being displayed, as with the time of the LVQ screen 1300, the camera 100 causes the displayed screen to transition to the LVQ-directed color mode selection screen 1100-2.

The camera 100 in the embodiment is configured in such a manner that the color mode setting function is allocated to the COLOR button 83 and an operation on the COLOR button 83 causes a transition to the color mode selection screen 1100. However, a configuration in which a dedicated button with the color mode setting function allocated thereto, such as the COLOR button 83, is not prepared and the color mode setting function is allocated to another button can be employed. A configuration in which to which of the buttons the color mode setting function is allocated is able to be set by the user can be employed. Moreover, a configuration in which, even if the COLOR button 83 is included, the color mode setting function is able to be allocated to another button can also be employed. Even in a case where the color mode setting function is allocated to another button, since, when the setting item for the color mode is currently displayed in the LVQ screen 1300, the COLOR icon 1352 is displayed, in one embodiment, a configuration in which only operating the COLOR button 83 causes a transition to the color mode selection screen 1100 can be employed.

Moreover, in the above-described embodiment, in the image capturing standby screen 1000 or the LVQ screen 1300 with the color mode setting item selected therein, pressing the COLOR button 83 causes a transition to the color mode selection screen 1100. However, a configuration in which, even in another screen such as a playback screen, pressing the COLOR button 83 causes a transition to the color mode selection screen 1100 can be employed. Moreover, in the above-described embodiment, a configuration in which, in a setting screen such as the menu screen 1200, the OLCQ screen 1400, or the LVQ screen 1300 with the color mode setting item not selected therein, to prevent a complicated screen transition, pressing the COLOR button 83 does not cause a transition to the color mode selection screen 1100 is employed. However, a configuration in which pressing the COLOR button 83 causes a transition to the color mode selection screen 1100 can be employed. Alternatively, a configuration in which, while pressing the COLOR button 83 does not cause a transition to the color mode selection screen 1100, a transition to the color mode selection screen 1100 is caused according to an operation performed on another operation unit with the color mode setting function allocated thereto can be employed.

### Other Embodiments

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the disclosure has been described with reference to embodiments, it is to be understood that the disclosure is not limited to the disclosed embodiments. The scope of the following claims is to be accorded the broadest interpretation so as to encompass all such modifications and equivalent structures and functions.

While a case where the above-described embodiment is implemented by a digital camera has been described above, the above-described embodiment can be implemented by, for example, a smartphone or a tablet personal computer (PC).

This application claims the benefit of Japanese Patent Application No. 2024-216548, filed Dec. 11, 2024, which is hereby incorporated by reference herein in its entirety.

What is claimed is:

1. An apparatus capable of setting, from a plurality of functions, a function concerning image creation to be performed on an image captured by a capturing unit, the apparatus comprising:
the capturing unit;
at least one memory storing a program; and
at least one processor that when executing the program causes the at least one processor to:
perform control to, in response to an item corresponding to the function concerning image creation having been selected in a first screen, display a selection screen used for selecting a function to be executed from the plurality of functions and setting the selected function and, in response to a predetermined operation for changing a setting value of the currently selected function having been performed in the selection screen, display a selection item for changing the setting value of the function selected in the selection screen; and
perform control to, in response to an item corresponding to the function concerning image creation having been selected in a second screen, without the selection screen being displayed, display a selection item for changing a setting value of a predetermined function included in the plurality of functions in the second screen.

2. The apparatus according to claim 1, wherein, as the function concerning image creation, one function included in the plurality of functions is able to be set.

3. The apparatus according to claim 1, wherein the predetermined function is, out of the plurality of functions, a function which has been subjected to initial setting in the apparatus or a function which has been set in the selection screen.

4. The apparatus according to claim 1,
wherein the control unit performs control to, in the first screen, in response to an operation for moving a cursor indicating a currently selected item included in a plurality of items to be displayed and, during selection by the cursor of an item corresponding to the function concerning image creation, fixing the selection being performed, display the selection screen, and
wherein the control unit performs control to, in the second screen, in response to a cursor indicating a currently selected item included in a plurality of items to be displayed being moved to an item corresponding to the function concerning image creation, display a selection item for the setting value of the predetermined function.

5. The apparatus according to claim 1, wherein the control unit performs control to, in response to a specific operation being performed when an item corresponding to the function concerning image creation is currently selected in the second screen, perform switching to displaying of the selection screen and, in response to one function being selected and set from the plurality of functions in the selection screen, perform switching to displaying of the second screen in which a selection item for setting a setting value of the selected function has been displayed.

6. The apparatus according to claim 5, wherein the control unit performs control to display the selection screen in response to the specific operation being performed in a state in which an image capturing standby screen different from the first screen and the second screen has been displayed.

7. The apparatus according to claim 6, wherein the specific operation is an operation on a specific button.

8. The apparatus according to claim 1, wherein the control unit performs control to, in the second screen, display an icon indicating a setting value which is currently set in the predetermined function, as an item corresponding to the function concerning image creation.

9. The apparatus according to claim 8, wherein the control unit performs control to, in the second screen, when the item corresponding to the function concerning image creation is currently set, display information indicating a function which is currently set out of the plurality of functions, separately from the icon.

10. The apparatus according to claim 1, wherein the control unit:
performs control to display the selection screen in response to a specific operation being performed when an item corresponding to the function concerning image creation is currently selected in the second screen; and
performs control to, in a case where a transition occurs from the first screen to the selection screen, display a predetermined item concerning the predetermined operation in the selection screen.

11. The apparatus according to claim 10,
wherein the first screen is a screen in which no live view image is displayed and the second screen is a screen in which a live view image is displayed, and
wherein the control unit:
performs control to, in a case where a transition occurs from the first screen to the selection screen, display a selection screen in which no live view image is displayed and, in response to a function being set in the selection screen, cause a transition to the first screen; and
performs control to, in a case where a transition occurs from the second screen to the selection screen, display a selection screen in which a live view image is displayed as a background and, in response to a function being set in the selection screen, cause a transition to the second screen.

12. The apparatus according to claim 1,
wherein the first screen is a menu screen in which a setting item is displayed without a captured image being displayed, and
wherein the second screen is a screen in which a setting item is displayed together with a live view image.

13. The apparatus according to claim 12, wherein the control unit performs control to, in the second screen, display a plurality of setting items and a selection item which is able to be set with respect to a currently selected setting item included in the plurality of setting items, in superimposition on a live view image.

14. The apparatus according to claim 11,
wherein the selection screen is a screen in which no live view image is displayed, and
wherein the control unit performs control to, in the selection screen, display a plurality of items respectively corresponding to the plurality of functions and explanatory text corresponding to at least a currently selected function.

15. The apparatus according to claim 1, wherein the control unit performs control to, in response to an item corresponding to the function concerning image creation being selected in the first screen, switch displaying to the selection screen and, in response to an instruction for detailed setting being issued in the selection screen, switch displaying to a setting screen including a selection item for setting detailed setting of a function selected in the selection screen.

16. The apparatus according to claim 15, wherein a setting screen for a first function included in the plurality of functions is a setting screen in which no live view image is displayed, and a setting screen for a second function included in the plurality of functions is a setting screen in which a live view image is displayed.

17. The apparatus according to claim 1, wherein the plurality of functions includes a first function which performs a processing operation corresponding to an image capturing scene set as detailed setting out of processing operations preliminarily set for respective image capturing scenes, and a second function which performs a filter effect set as detailed setting out of a plurality of filter effects.

18. The apparatus according to claim 17, wherein the first function is a picture style function, and the second function is a color filter function.

19. A method for an apparatus capable of selecting, from a plurality of functions, a function concerning image creation to be performed on an image captured by a capturing unit, the method comprising:
performing control to, in response to an item corresponding to the function concerning image creation having been selected in a first screen, display a selection screen used for selecting a function to be executed on an image from the plurality of functions and, in response to an instruction for detailed setting being issued in the selection screen, display a selection item for setting detailed setting of a function selected in the selection screen; and
performing control to, in response to an item corresponding to the function concerning image creation having been selected in a second screen, without the selection screen being displayed, enable detailed setting of a predetermined function included in the plurality of functions.

20. A non-transitory computer-readable storage medium storing a program that, when executed by a computer, causes the computer to perform a method for an apparatus capable of selecting, from a plurality of functions, a function concerning image creation to be performed on an image captured by a capturing unit, the method comprising:
performing control to, in response to an item corresponding to the function concerning image creation having been selected in a first screen, display a selection screen used for selecting a function to be executed on an image from the plurality of functions and, in response to an instruction for detailed setting being issued in the selection screen, display a selection item for setting detailed setting of a function selected in the selection screen; and
performing control to, in response to an item corresponding to the function concerning image creation having been selected in a second screen, without the selection screen being displayed, enable detailed setting of a predetermined function included in the plurality of functions.
